(19) United States
(12) Patent Application Publication
(10) Pub. No.: US 2025/0113404 A1
(43) Pub. Date: Apr. 3, 2025

(54) SYSTEM AND METHOD FOR MANAGING STATE TRANSITIONS OF A MULTICAST UE IN A WIRELESS COMMUNICATION SYSTEM

(71) Applicant: Samsung Electronics Co., Ltd., Suwon-si (KR)

(72) Inventors: Vinay Kumar SHRIVASTAVA, Bangalore (IN); Sangkyu BAEK, Suwon-si (KR); Sriganesh RAJENDRAN, Bangalore (IN)

(21) Appl. No.: 18/895,972

(22) Filed: Sep. 25, 2024

(30) Foreign Application Priority Data
Sep. 29, 2023 (IN) 202341065512
Oct. 25, 2023 (IN) 202341072530
Oct. 26, 2023 (IN) 202341072863
Sep. 20, 2024 (IN) 2023 41065512

(51) Int. Cl. H04W 76/27; H04W 76/40

(52) U.S. Cl. CPC H04W 76/27; H04W 76/40

(57) ABSTRACT

The disclosure relates to a fifth generation (5G) or sixth generation (6G) communication system for supporting a higher data transmission rate. A method and a system for manage state transitions of a multicast broadcast service (MBS) user equipment (UE), manage a service continuity of the multicast UE, and manage packet data convergence protocol (PDCP) synchronizations of the multicast UE in a wireless network are provided. A radio resource control (RRC) connection resume procedure is initiated when point-to-multipoint (PTM) configurations are not available in a cell after cell selection and/or cell reselection, and the UE has at least one activated session in the RRC_INACTIVE state. The RRC connection resume procedure is also initiated when the cell after cell selection and/or cell reselection is an MBS control channel (MCCH)-less cell and the UE has at least one activated session (for example, indicated to monitor G-RNTI) in the RRC_INACTIVE state. Further, multicast MRBs are handled during motility by providing a mechanism for multicast reception across cells in the radio access network (RAN) notification area (RNA), where PDCP synchronizations are indicated or not indicated in the multicast session.

### CROSS-REFERENCE TO RELATED APPLICATION(S)

This application is based on and claims priority under 35 U.S.C. § 119 (a) of an Indian Provisional patent application No. 20/234,1065512, filed on Sep. 29, 2023, in the Indian Intellectual Property Office, of an Indian Provisional patent application No. 20/234,1072530, filed on Oct. 25, 2023, in the Indian Intellectual Property Office, of an Indian Provisional patent application No. 20/234,1072863, filed on Oct. 26, 2023, in the Indian Intellectual Property Office, and of an Indian Complete patent application No. 202341065512, filed on Sep. 20, 2024, in the Indian Intellectual Property Office, the disclosure of each of which is incorporated by reference herein in its entirety.

### BACKGROUND

### 1. Field

The disclosure relates to wireless networks. More particularly, the disclosure relates to a method and system for managing state transitions, service continuity, and packet data convergence protocol (PDCP) synchronization of a multicast user equipment (UE) in wireless networks.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHZ, but also in “Above 6 GHz” bands referred to as mm Wave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The present disclosure relates to wireless communication systems and, more specifically, the present disclosure relates to a method for managing state transitions of a multicast broadcast service (MBS) multicast user equipment (UE) in a wireless network. The method includes performing a cell selection when the UE transitions from a radio resource control (RRC) connected state to a RRC inactive state. Further, the method includes detecting whether the UE has selected a cell different than a serving cell. The UE receives a RRC release message with a suspend configuration including point-to-multipoint (PTM) configurations on the selected cell. Further, the method includes determining whether a multicast MBS control channel (MCCH) on the selected cell does not provide the PTM configurations for a multicast session. In addition, the method includes performing, by the UE, one of receiving the multicast session on the selected cell when the multicast MCCH on the selected cell provides the PTM configurations for the multicast session, and initiating a RRC connection resume procedure to avail the multicast session in the RRC connected state if the multicast MCCH on the selected cell does not provide the PTM configurations for the multicast session.

In an embodiment of the disclosure, The method includes determining whether the UE has at least one activated session on the serving cell for multicast reception in the RRC inactive state. Further, the method includes performing a cell reselection and acquiring the multicast MCCH on a reselected cell. Further, the method includes determining whether the multicast MCCH on the reselected cell does not provide the PTM configurations for the multicast session. In addition, the method includes performing, by the UE, one of receiving the multicast session on the reselected cell if the multicast MCCH on the reselected cell provides the PTM configurations for the multicast session, and initiating the RRC connection resume procedure to avail the multicast session in the RRC connected state if the multicast MCCH on the reselected cell does not provide the PTM configurations for the multicast session.

In an embodiment of the disclosure, the method includes determining whether the UE is configured with an MBS multicast reception in the RRC inactive state. Further, the method includes determining whether the PTM configuration is not available in the cell after cell selection or cell reselection for the multicast session that the UE has joined and for which the UE is not indicated to stop monitoring a G-radio network temporary identifier (G-RNTI). In addition, the method includes initiating the RRC connection resume procedure if the PTM configuration for the multicast session is not available.

In accordance with another aspect of the disclosure, a method for managing a service continuity of a multicast UE in a wireless network is provided. The method includes selecting or reselecting a multicast MBS control channel (MCCH)-less cell in a RRC inactive state. The MCCH-less cell is a cell on which a system information block (SIB24) is not scheduled in SIB1. Further, the method includes determining at least one of whether the UE has at least one active multicast session in the RRC inactive state and whether the UE is monitoring a physical downlink control channel (PDCCH) by using at least one G-RNTI. In addition, the method includes initiating a RRC connection resume procedure to receive a multicast configuration from a network apparatus when the UE has at least one active multicast session in the RRC inactive state, or the UE is monitoring the PDCCH by using the at least one G-RNTI. The UE transitions to a RRC connected state upon initiation of the RRC connection resume procedure.

In an embodiment of the disclosure, the method includes performing a cell selection when the UE transitions from a RRC connected state to the RRC inactive state. Further, the method includes detecting whether the UE has selected a cell different than a serving cell in which the UE received a RRC release message with a suspend configuration including PTM configurations and the selected cell is a MCCH-less cell. In addition, the method includes initiating a RRC connection resume procedure to avail at least one active multicast session in the RRC connected state, if the UE has selected the cell different than the serving cell and the selected cell is a MCCH-less cell.

In an embodiment of the disclosure, the method includes determining whether the UE is configured with at least one activated multicast session in the RRC release message received with the suspend configuration. In addition, the method includes initiating the RRC connection resume procedure in the selected cell to receive the multicast configuration from the network apparatus when the UE is configured with at least one activated multicast session in the RRC release message received with the suspend configuration. The UE transitions to the RRC connected state upon initiation of the RRC connection resume procedure.

In an embodiment of the disclosure, the method includes determining whether the UE is configured for monitoring the PDCCH by using at least one G-RNTI in the RRC release message received with the suspend configuration. In addition, the method includes initiating the RRC connection resume procedure to receive the multicast configuration from the network apparatus when the UE is configured for monitoring the PDCCH by using at least one G-RNTI in the RRC release message received with the suspend configuration. The UE transitions to the RRC connected state upon initiation of the RRC connection resume procedure.

In an embodiment of the disclosure, the method includes determining whether the UE is configured to receive an MBS multicast in the RRC inactive state. Further, the method includes determining whether the UE has selected or reselected a cell that is different than the cell where the multicast session was received when the UE is in the RRC connected state and the selected cell or the reselected cell is a MCCH-less cell. In addition, the method includes initiating the RRC connection resume procedure for multicast reception if the UE is configured to receive an MBS multicast in the RRC inactive state, and the selected cell or the reselected cell is a MCCH-less cell.

In an embodiment of the disclosure, the method includes determining whether the UE is configured to receive a multicast in the RRC inactive state for at least one MBS session indicated by temporary mobile group identities (TMGIs), wherein the TMGIs indications are provided in a group paging message. Further, the method includes determining whether the UE has selected or reselected a cell that is different than the cell where the multicast was received when the UE is in the RRC connected state and the selected or reselected cell is a MCCH-less cell. In addition, the method included initiating the RRC connection resume procedure for multicast reception if the UE has selected or reselected the cell that is different than the cell where the multicast was received in RRC connected state and the selected or reselected cell is a MCCH-less cell.

In accordance with another aspect of the disclosure, a method for managing packet data convergence protocol (PDCP) synchronizations of a multicast UE in a wireless network is provided. The method includes performing a transition to a first cell. Further, the method includes determining whether the first cell is PDCP synchronized to a source cell for an MBS multicast session or radio bearer. In addition, the method includes performing, by the UE, one of re-establishing a radio link control (RLC) entity and continuing a pertinent packet data convergence protocol (PDCP) entity when the first cell is PDCP synchronized to the source cell for the MBS multicast session or radio bearer, and establishing at least one of the RLC entity and the PDCP entity based on a new configuration received via a multicast MCCH message in the first cell, when the first cell is not PDCP synchronized to the source cell for the MBS multicast session or radio bearer.

In an embodiment of the disclosure, the first cell includes at least one of a selected cell determined during a transition of the UE from a RRC connected state to a RRC inactive state configured to receive multicast session, and a reselected cell determined during a mobility of the UE receiving the multicast session in the RRC inactive state.

In an embodiment of the disclosure, the method includes releasing an existing multicast MBS radio bearer (MRB) and adding a new multicast MRB when the first cell is not PDCP synchronized to the source cell for the MBS multicast session.

In an embodiment of the disclosure, the method includes receiving an indicator for PDCP count synchronization of the MBS multicast session. Further, the method includes determining whether the PDCP count of the MBS multicast session or radio bearer is synchronized within a RAN notification area (RNA). In addition, the method includes performing, by the UE, one of performing a multicast MRB modification when the UE moves to the first cell when the PDCP count of the MBS multicast session or radio bearer is synchronized within the RNA, and performing the multicast MRB modification or a release and establishment procedure when PTM configurations are updated via a multicast MCCH message in the first cell, when the PDCP count of the MBS multicast session or radio bearer is not synchronized within the RNA.

In accordance with another aspect of the disclosure, a UE for managing state transitions of a multicast broadcast service (MBS) in a wireless network is provided. The UE includes memory, a processor coupled to the memory, and an MBS controller communicatively coupled to the memory and the processor. The MBS controller performs a cell selection when the UE transitions from a radio resource control (RRC) connected state to a RRC inactive state. Further, the MBS controller detects whether the UE has selected a cell different than a serving cell. The UE receives a RRC release message with a suspend configuration including point-to-multipoint (PTM) configurations on the selected cell. Further, the MBS controller determines whether a multicast MBS control channel (MCCH) on the selected cell does not provide the PTM configurations for a multicast session. In addition, the MBS controller performs one of receives the multicast session on the selected cell when the multicast MCCH on the selected cell provides the PTM configurations for the multicast session, and initiates a RRC connection resume procedure to avail the multicast session in the RRC connected state if the multicast MCCH on the selected cell does not provide the PTM configurations for the multicast session.

In an embodiment of the disclosure, the MBS controller determines whether the UE has at least one activated session on the serving cell for multicast reception in the RRC inactive state. Further, the MBS controller performs a cell reselection and acquiring the multicast MCCH on a reselected cell. Further, the MBS controller determined whether the multicast MCCH on the reselected cell does not provide the PTM configurations for the multicast session. In addition, the MBS controller performs one of receives the multicast session on the reselected cell if the multicast MCCH on the reselected cell provides the PTM configurations for the multicast session, and initiates the RRC connection resume procedure to avail the multicast session in the RRC connected state if the multicast MCCH on the reselected cell does not provide the PTM configurations for the multicast session.

In an embodiment of the disclosure, the MBS controller determines whether the UE is configured with an MBS multicast reception in the RRC inactive state. Further, the MBS controller determined whether the PTM configuration is not available in the cell after cell selection or cell reselection for the multicast session that the UE has joined and for which the UE is not indicated to stop monitoring a G-radio network temporary identifier (G-RNTI). In addition, the MBS controller initiates the RRC connection resume procedure if the PTM configuration for multicast session is not available.

In accordance with another aspect of the disclosure, a UE for managing a service continuity in a wireless network is provided. The UE includes memory, a processor coupled to the memory, and a service continuity controller communicatively coupled to the memory and the processor. The service continuity controller selects or reselects a multicast MBS control channel (MCCH)-less cell in a RRC inactive state. The MCCH-less cell is a cell on which a system information block (SIB24) is not scheduled in SIB1. Further, the service continuity controller determines at least one of whether the UE has at least one active multicast session in the RRC inactive state and whether the UE is monitoring a physical downlink control channel (PDCCH) by using at least one G-RNTI. In addition, the service continuity controller initiates a RRC connection resume procedure to receive a multicast configuration from a network apparatus when the UE has at least one active multicast session in the RRC inactive state, or the UE is monitoring the PDCCH by using the at least one G-RNTI. The UE transitions to a RRC connected state upon initiation of the RRC connection resume procedure.

In an embodiment of the disclosure, the service continuity controller performs a cell selection when the UE transitions from a RRC connected state to the RRC inactive state. Further, the service continuity controller detects whether the UE has selected a cell different than a serving cell in which the UE received a RRC release message with a suspend configuration including PTM configurations and the selected cell is a MCCH-less cell. In addition, the service continuity controller initiates a RRC connection resume procedure to avail at least one active multicast session in the RRC connected state, if the UE has selected the cell different than the serving cell and the selected cell is a MCCH-less cell.

In an embodiment of the disclosure, the service continuity controller determines whether the UE is configured with at least one activated multicast session in the RRC release message received with the suspend configuration. In addition, the service continuity controller initiates the RRC connection resume procedure in the selected cell to receive the multicast configuration from the network apparatus when the UE is configured with at least one activated multicast session in the RRC release message received with the suspend configuration. The UE transitions to the RRC connected state upon initiation of the RRC connection resume procedure.

In an embodiment of the disclosure, the service continuity controller determines whether the UE is configured for monitoring the PDCCH by using at least one G-RNTI in the RRC release message received with the suspend configuration. In addition, the service continuity controller initiates the RRC connection resume procedure to receive the multicast configuration from the network apparatus when the UE is configured for monitoring the PDCCH by using at least one G-RNTI in the RRC release message received with the suspend configuration. The UE transitions to the RRC connected state upon initiation of the RRC connection resume procedure.

In an embodiment of the disclosure, the service continuity controller determines whether the UE is configured to receive an MBS multicast in the RRC inactive state. Further, the service continuity controller determines whether the UE has selected or reselected a cell that is different than the cell where the multicast session was received when the UE is in the RRC connected state and the selected cell or the reselected cell is a MCCH-less cell. In addition, the service continuity controller initiates the RRC connection resume procedure for multicast reception if the UE is configured to receive an MBS multicast in the RRC inactive state, and whether the selected cell or the reselected cell is a MCCH-less cell.

In an embodiment of the disclosure, the service continuity controller determines whether the UE is configured to receive a multicast in the RRC inactive state for at least one MBS session indicated by temporary mobile group identities (TMGIs). The TMGIs indications are provided in a group paging message. Further, the service continuity controller determines whether the UE has selected or reselected a cell that is different than the cell where the multicast was received when the UE is in the RRC connected state and the selected or reselected cell is a MCCH-less cell. In addition, the service continuity controller initiates the RRC connection resume procedure for multicast reception if the UE has selected or reselected the cell that is different than the cell where the multicast was received in RRC connected state and the selected or reselected cell is a MCCH-less cell.

In accordance with another aspect of the disclosure, a UE for managing packet data convergence protocol (PDCP) synchronizations in a wireless network is provided. The UE includes memory, a processor coupled to the memory, and a PDCP controller communicatively coupled to the memory and the processor. The PDCP controller performs a transition to a first cell. Further, the PDCP controller determines whether the first cell is PDCP synchronized to a source cell for an MBS multicast session or radio bearer. In addition, the PDCP controller performs one of re-establishes a radio link control (RLC) entity and continuing a pertinent packet data convergence protocol (PDCP) entity when the first cell is PDCP synchronized to the source cell for the MBS multicast session or radio bearer, and establishes at least one of the RLC entity and the PDCP entity based on a new configuration received via a multicast MCCH message in the first cell, when the first cell is not PDCP synchronized to the source cell for the MBS multicast session or radio bearer.

In an embodiment of the disclosure, the first cell includes at least one of a selected cell determined during a transition of the UE from a RRC connected state to a RRC inactive state configured to receive multicast session, and a reselected cell determined during a mobility of the UE receiving the multicast session in the RRC inactive state.

In an embodiment of the disclosure, the PDCP controller releases an existing multicast MBS radio bearer (MRB) and adds a new multicast MRB when the first cell is not PDCP synchronized to the source cell for the MBS multicast session.

In an embodiment of the disclosure, the PDCP controller receives an indicator for PDCP count synchronization of the MBS multicast session. Further, the PDCP controller determines whether the PDCP count of the MBS multicast session or radio bearer is synchronized within a RAN notification area (RNA). In addition, the PDCP controller performs one of performs a multicast MRB modification when the UE moves to the first cell when the PDCP count of the MBS multicast session or radio bearer is synchronized within the RNA, and performs the multicast MRB modification or a release and establishment procedure when PTM configurations are updated via a multicast MCCH message in the first cell, when the PDCP count of the MBS multicast session or radio bearer is not synchronized within the RNA.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram that illustrates a schematic of a user equipment (UE) implemented to carry out a disclosed subject matter according to an embodiment of the disclosure;

FIG. 1B is a block diagram that illustrates a schematic of a user equipment (UE) implemented to carry out a disclosed subject matter according to an embodiment of the disclosure;

FIG. 1C is a block diagram that illustrates a schematic of a user equipment (UE) implemented to carry out a disclosed subject matter according to an embodiment of the disclosure;

FIG. 2 is a flow diagram that illustrates a method for managing a state transition based cell selection for NR MBS multicast reception in RRC_INACTIVE state for a UE with at least one activated multicast session according to an embodiment of the disclosure;

FIG. 3 is a flow diagram that illustrates a method for managing a state transition based cell selection for NR MBS multicast reception in RRC_INACTIVE state for a UE with at least one deactivated multicast session according to an embodiment of the disclosure;

FIG. 4 is a flow diagram that illustrates a method for managing a state transition based cell selection for NR MBS multicast reception in RRC_INACTIVE state for a UE with at least one deactivated multicast session according to an embodiment of the disclosure;

FIG. 5 is a flow diagram that illustrates a method for managing a state transition based cell selection for NR MBS multicast reception in RRC_INACTIVE state for a UE with at least one deactivated multicast session according to an embodiment of the disclosure;

FIG. 6 is a flow diagram that illustrates a method for managing a cell reselection for NR MBS multicast reception in RRC_INACTIVE state for a UE with at least one deactivated multicast session according to an embodiment of the disclosure;

FIG. 7 is a flow diagram that illustrates a method for managing a cell reselection for NR MBS multicast reception in RRC_INACTIVE state for a UE with at least one deactivated multicast session according to an embodiment of the disclosure;

FIG. 8 is a flow diagram that illustrates a method for managing a cell reselection for NR MBS multicast reception in RRC_INACTIVE state for a UE with at least one deactivated multicast session according to an embodiment of the disclosure;

FIG. 9 is a flow diagram that illustrates a method for managing a service continuity for NR MBS multicast reception in RRC_INACTIVE state for a UE moving to a multicast MCCH-less cell according to an embodiment of the disclosure;

FIG. 10 is a flow diagram that illustrates a method for managing a service continuity for NR MBS multicast reception in RRC_INACTIVE state for a UE moving to a multicast MCCH-less cell in conjunction with a PDCP synchronization indicator according to an embodiment of the disclosure;

FIG. 11 is a flow diagram that illustrates a method for managing a service continuity for NR MBS multicast reception in RRC_INACTIVE state for a UE moving to a multicast MCCH-less cell in conjunction with a neighbor cell list (NCL) according to an embodiment of the disclosure;

FIG. 12 is a flow diagram that illustrates a method for managing PDCP synchronization for NR MBS multicast reception in RRC_INACTIVE state during mobility across cells according to an embodiment of the disclosure;

FIG. 13 is a flow diagram that illustrates a method for managing state transitions of a multicast broadcast service (MBS) multicast UE in a wireless network according to an embodiment of the disclosure;

FIG. 14A is a flow diagram that illustrates a method for initiating a RRC connection resume procedure based on PTM configurations according to an embodiment of the disclosure;

FIG. 14B is a flow diagram that illustrates a method for initiating a RRC connection resume procedure based on an availability of PTM configurations for a multicast session according to an embodiment of the disclosure;

FIG. 15 is a flow diagram that illustrates a method for managing a service continuity of a multicast UE in a wireless network according to an embodiment of the disclosure;

FIG. 16 is a flow diagrams that illustrate a method for initiating a RRC connection resume procedure when a UE transitions from a RRC connected state to a RRC inactive state according to an embodiment of the disclosure;

FIG. 17 is a flow diagram that illustrates a method for initiating a RRC connection resume procedure when a UE is configured with an activated multicast session according to an embodiment of the disclosure;

FIG. 18 is a flow diagram that illustrates a method for initiating a RRC connection resume procedure based on a PDCCH monitoring using a G-RNTI according to an embodiment of the disclosure;

FIG. 19 is a flow diagram that illustrates a method for initiating a RRC connection resume procedure when a UE receives an MBS multicast in a RRC inactive state according to an embodiment of the disclosure;

FIG. 20 is a flow diagram that illustrates a method for initiating a RRC connection resume procedure when a UE receives a multicast in a RRC inactive state according to an embodiment of the disclosure;

FIG. 21 is a flow diagram that illustrates a method for managing PDCP synchronizations of a multicast UE in a wireless network according to an embodiment of the disclosure;

FIG. 22 is a block diagram of a terminal (or a user equipment (UE) according to an embodiment of the disclosure; and

FIG. 23 is a block diagram of a base station, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, or the like, used herein to describe various elements, these elements are not be limited by these terms. These terms are generally used to distinguish one element from another.

The various actions, acts, blocks, steps, or the like in the method is performed in the order presented, in a different order or simultaneously. Further, in some embodiments of the disclosure, some of the actions, acts, blocks, steps, or the like are omitted, added, modified, skipped, or the like without departing from the scope of the proposed method.

In the prior art, legacy systems (such as third generation partnership project (3GPP) Release 17 MBS) only enable UEs to receive multicast services if they are RRC_CONNECTED. However, it is feasible for some UEs, in 3GPP Release 18 eMBS, to receive multicast sessions when in the RRC_INACTIVE state. A potential issue occurs with UEs that potentially receive MBS multicast service while in the RRC_INACTIVE state. In some instances, for example, UEs in the RRC_INACTIVE state may perform state transition and/or mobility (such as cell selection and reselection) and depart the multicast service's coverage area. For example, UEs may experience service disruptions as a result of mobility, and no clear method exists to ensure the sustainability and continuation of multicast services when UEs move about.

New radio multicast broadcast service (NR MBS) multicast service is a feature introduced in 5G networks as part of the 3GPP standards to support multicast and broadcast communications. It enables efficient delivery of the same content to multiple users simultaneously, leveraging the capabilities of 5G. NR MBS builds on 5G's advanced infrastructure and is designed to meet the demands for services like live video streaming, emergency alerts, public safety communications, and massive IoT. In addition, NR MBS may offer broadcast services in which the intended contents may be directed towards every UE in the broadcast coverage area, as well as multicast services in which intended common contents are targeted to a subset of UEs that have joined the multicast group in the multicast coverage area. One radio cell or more may make up this coverage region. The legacy system (such as, 3GPP Release 17 MBS) only allows UEs to receive multicast services while they are RRC_CONNECTED. However, it is possible, in 3GPP Release 18 eMBS, that some UEs can receive multicast sessions when in the RRC_INACTIVE state.

A possible problem exists with UEs that can receive MBS multicast service while in the RRC_INACTIVE state. In some cases, for example, UEs in the RRC_INACTIVE state may conduct state transition and/or mobility (for example, cell selection and cell reselection) and may leave the multicast service's coverage area. For example, UEs may experience service outages as a result of mobility, and there is no clear mechanism in place to assure multicast service sustainability and continuity while UEs move about. In order to handle a high number of multicast UEs, multicast reception must also be enabled in the RRC_INACTIVE state. These UEs may encounter a circumstance in which PTM configuration is unavailable in the cell following cell selection and/or reselection.

In certain scenarios, for example, deployments for multicast service reception in the RRC_INACTIVE state may or may not have packet data convergence protocol (PDCP) synchronization for the multicast services across the geographic region or area (for example, radio access network (RAN) notification area, i.e., RNA, or one or more cells in the area), and/or one or more cells may or may not be provided with multicast MBS control channel (MCCH) transmission. Consider MCCH-less transmission for multicast reception under RRC_INACTIVE. In such cases, UEs may experience service outages owing to mobility, and there is no clear method in place to maintain multicast service continuity while UEs are mobile. These UEs may encounter a circumstance in which the cell selected and/or reselected is the MCCH-less cell.

In addition, due to mobility, UEs may experience service outages, and there is no clear method in place to assure multicast service continuity when UEs are mobile. In order to handle a high number of multicast UEs, multicast reception must also be enabled in the RRC_INACTIVE state. It is unclear whether PDCP synchronization is possible for various sessions across cells, or how MBS radio bearers for these sessions are managed during mobility. This problem is neither addressed nor stated in the 3GPP standards.

Hence, is desirable to address the above mentioned problems and disadvantages or at least provide a useful alternative.

The proposed solution describes a method and system for managing state transitions of an MBS UE, service continuity of a multicast UE, and PDCP synchronizations of a multicast UE in a wireless network. When PTM configurations are not accessible in a cell following cell selection and/or cell reselection, the RRC connection resume procedure is launched, and the UE has at least one active session in the RRC_INACTIVE state. Thus, a method is provided to assure the multicast service's sustenance and continuance, as well as the state transition and/or mobility of UEs in the RRC_INACTIVE state.

Further, the proposed method starts the RRC connection resume mechanism when the cell following cell selection and/or cell reselection is MCCH-less and the UE has at least one active session in the RRC_INACTIVE state. Furthermore, the proposed method can handle multicast MRBs during mobility by providing a mechanism for consistent multicast reception across cells in the RNA, regardless of whether PDCP synchronizations are stated or not in the multicast session. As a result, the proposed method can regulate RRC state transition while also preventing multicast session loss while the UE is in the RRC_Inactive state.

The principal aspect of the embodiments herein is to manage state transitions of an MBS UE, manage a service continuity of a multicast UE, and manage PDCP synchronizations of a multicast UE in a wireless network.

Yet another aspect of the embodiments herein is to initiate a RRC connection resume procedure when PTM configurations are not available in a cell after cell selection and/or cell reselection, and the UE has at least one activated session in the RRC_INACTIVE state.

Yet another aspect of the embodiments herein is to initiate a RRC connection resume procedure when the cell after cell selection and/or cell reselection is a MCCH-less cell and the UE has at least one activated session (for example, indicated to monitor G-RNTI) in the RRC_INACTIVE state.

Yet another aspect of the embodiments herein is to handle multicast MRBs during motility by providing a mechanism for reliable multicast reception across cells in the RNA, where PDCP synchronizations are indicated or not indicated in the multicast session.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

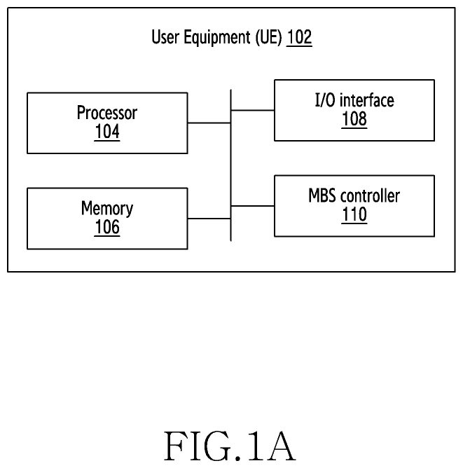

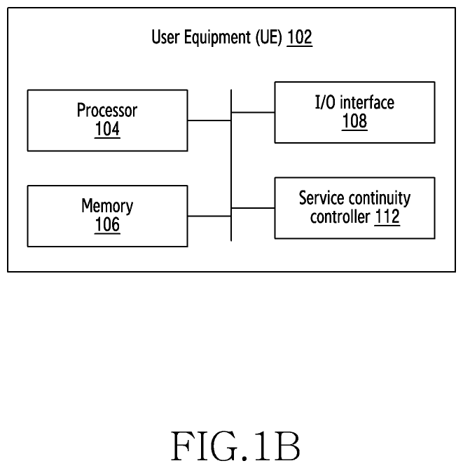

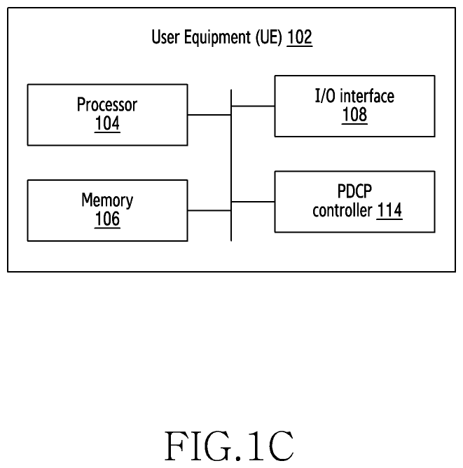

Referring now to the drawings, and more particularly to FIGS. 1A, 1B, 1C, 2 to 13, 14A, 14B, and 15 to 23 where similar reference characters denote corresponding features consistently throughout the figures, there are shown preferred embodiments.

FIGS. 1A, 1B, and 1C are block diagrams that illustrates a schematic of a UE 102 implemented to carry out a disclosed subject matter according to various embodiments of the disclosure. For instance, the UE 102 may include, but not limited to a smartphone, a tablet, a laptop, a personal computer (PC), a television, a connected car, an IoT device, and the like.

Referring to FIG. 1A, the UE 102 includes a processor 104, memory 106, an I/O interface 108, and an MBS controller 110. Each component is explained further below.

The processor 104 communicates with the memory 106, the I/O interface 108 and the MBS controller 110. The processor 104 is configured to execute instructions stored in the memory 106 and to perform various processes. The processor 104 may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The memory 106 includes storage locations to be addressable through the processor 104. The memory 106 is not limited to volatile memory and/or non-volatile memory. Further, the memory 106 may include a plurality of computer-readable storage media. The memory 106 may include non-volatile storage elements. For example, non-volatile storage elements may include magnetic hard discs, optical discs, floppy discs, flash memories, or forms of electrically programmable memories (EPROM) or electrically erasable and programmable (EEPROM) memories.

The I/O interface 108 transmits the information between the memory 106 and external peripheral devices. The peripheral devices are the input-output devices associated with the UE 102. Further, the MBS controller 110 communicates with the I/O interface 108 and the memory 106. The MBS controller 110 may be communicatively coupled to the memory 106 and the processor 104. The MBS controller 110 is an innovative hardware that is realized through the physical implementation of both analog and digital circuits, including logic gates, integrated circuits, microprocessors, microcontrollers, memory circuits, passive and active electronic components, as well as optical components.

In an embodiment of the disclosure, the MBS controller 110 performs a cell selection when the UE 102 transitions from a radio resource control (RRC) connected state to a RRC inactive state. Cell selection refers to the process where the UE 102 selects the most appropriate cell to connect with when it is powered on or when it loses its connection to the network. This process is crucial for ensuring that the UE 102 maintains a stable and reliable connection, offering the best possible service based on signal strength, quality, and network parameters. The RRC connected state is when the UE 102 has an active connection with the network and is actively exchanging data or control information. In this state, the network assigns dedicated resources to the UE 102, and the UE 102 maintains a continuous connection with the gNB. Further, the RRC inactive state is an intermediate state to reduce signaling overhead and conserve a battery life when the UE 102 is not actively exchanging data, but still needs to maintain its connection with the network for quick reactivation.

In an embodiment of the disclosure, the MBS controller 110 detects whether the UE 102 has selected a cell different than a serving cell. The serving cell refers to the cell that handles all data transfers and signaling for the UE 102, ensuring a stable and reliable connection. For instance, the serving cell may include a primary serving cell (PCell) and a secondary serving cell (SCell). Further, the UE 102 receives a RRC release message with a suspend configuration including point-to-multipoint (PTM) configurations on the serving cell. The RRC release message releases the active connection between the UE 102 and the network when the UE 102 is no longer actively transmitting or receiving data. If the UE 102 has been idle for a while, and there is no ongoing data transmission, the network may send an RRC release message to save resources. Another relevant scenario for multicast service delivery is the congestion for the serving cell and as a result, the UE(s) receiving MBS multicast session(s) may be transitioned to RRC inactive state by sending a RRC release message with a suspend configuration including point-to-multipoint (PTM) configurations for multicast session(s).

In an embodiment of the disclosure, the MBS controller 110 determines whether a multicast MBS control channel (MCCH) on the selected cell does not provide the PTM configurations for a multicast session. The multicast MCCH is a control channel used to manage multicast services. The multicast MCCH carries essential control information about available MBS services, resource allocations, and session management, allowing the UE 102 or multiple UEs to join and participate in multicast transmissions efficiently. The multicast MCCH plays a vital role in ensuring seamless, coordinated communication for applications such as live streaming, emergency broadcasts, and group communication services.

In an embodiment of the disclosure, the MBS controller 110 receives the multicast session on the selected cell when the multicast MCCH on the selected cell provides the PTM configurations for the multicast session, else initiates a RRC connection resume procedure to avail the multicast session in the RRC connected state. The RRC connection resume procedure allows the UE 102 to resume its connection with the network after being in a low-power state, such as the RRC inactive state. This procedure enables the UE 102 to resume communication without going through a full connection setup process, thereby reducing signaling overhead and latency.

In an embodiment of the disclosure, the MBS controller 110 determines whether the UE 102 has at least one activated session on the serving cell for multicast reception in the RRC inactive state. The activated session refers to an ongoing session that allows the UE 102 to transmit and receive data, voice, or other services via the network. Multicast reception refers to refers to the ability to deliver data to multiple UEs simultaneously through a single transmission, rather than sending individual streams. This capability is essential for applications that involve large-scale, simultaneous data distribution, such as live video streaming, software updates, or public safety alerts. Multicast reception is efficient because it reduces network resource consumption by sending the same data to a group of UEs at once.

In an embodiment of the disclosure, the MBS controller 110 performs a cell reselection and acquiring the multicast MCCH on a reselected cell. Cell reselection refers to a process in which the UE 102 selects a new cell to camp on while in an idle or inactive state. This occurs when the UE 102 is not actively communicating with the network but needs to ensure it remains connected to the best possible cell for future communication needs. Cell reselection is essential for maintaining optimal connectivity, network efficiency, and quality of service in wireless networks, ensuring that the UE 102 remains within the best possible coverage area as it moves around.

In an embodiment of the disclosure, the MBS controller 110 determines if the multicast MCCH on the reselected cell does not provide PTM configurations for the multicast session. If the multicast MCH on the reselection cell has the PTM configurations, the UE 102 will receive the multicast session on the reselected cell. Otherwise, the UE 102 initiates the RRC connection resume procedure to continue the multicast session in the RRC connected state.

In an embodiment of the disclosure, the MBS controller 110 determines whether the UE 102 is configured with an MBS multicast reception in the RRC inactive state. MBS multicast reception enables the UE 102 to efficiently receive large-scale data broadcasts from the network. This is particularly useful for applications requiring the delivery of the same data to many users simultaneously, such as live streaming, IoT updates, and public safety alerts. The large scale data may be transmitted via a single transmission, thus saving bandwidth and reducing network load.

In an embodiment of the disclosure, the MBS controller 110 determines whether the PTM configuration is not available in the cell following cell selection or cell reselection for the multicast session that the UE has joined and for which the UE is not instructed to stop monitoring a group-radio network temporary identifier (G-RNTI). The G-RNTI allows the network to send a single transmission that can be received by multiple UEs subscribing to the multicast service. G-RNTI allows efficient data transmission to all UEs subscribed to the multicast service. UEs that are part of a multicast group and have subscribed to certain services are identified using the G-RNTI.

Referring to FIG. 1B, the UE 102 includes the processor 104, the memory 106, the I/O interface 108, and a service continuity controller 112. Each component is explained further below. The service continuity controller 112 communicates with the I/O interface 108 and the memory 106. The service continuity controller 112 may be communicatively coupled to the memory 106 and the processor 104. The service continuity controller 112 is an innovative hardware that is realized through the physical implementation of both analog and digital circuits, including logic gates, integrated circuits, microprocessors, microcontrollers, memory circuits, passive and active electronic components, as well as optical components.

In an embodiment of the disclosure, the service continuity controller 112 selects or reselects a multicast MBS control channel (MCCH)-less cell in a RRC inactive state. The MCCH-less cell refers to a cell that does not have a dedicated MCCH for MBS-related control information. Instead, control information is delivered using only RRC signaling, while the UE 102 is in RRC connected state. Here, the MCCH-less cell may be a cell on which SIB24 is not scheduled in SIB1. The SIB24 includes information related to how the UE 102 can receive and process multicast and broadcast data within the network. For instance, the SIB24 information may include MBS area information, session information, service availability, frequency information, and the like.

In an embodiment of the disclosure, the service continuity controller 112 determines whether the UE 102 has at least one active multicast session in the RRC inactive state and whether the UE 102 is monitoring a physical downlink control channel (PDCCH) by using at least one G-RNTI. The PDCCH is responsible for providing the UE 102 with instructions on how to receive and decode data transmissions on the downlink (DL) and uplink (UL) traffic channels, making it essential for managing the allocation of network resources and ensuring reliable communication between the network and the UE 102. The PDCCH is critical for ensuring reliable data transmission through proper HARQ management and error correction procedures.

In an embodiment of the disclosure, the service continuity controller 112 initiates the RRC connection resume procedure to receive a multicast configuration from a network apparatus. The RRC connection resume procedure is initiated when the UE 102 has at least one active multicast session in the RRC inactive state or when the UE 102 is monitoring the PDCCH by using the at least one G-RNTI. When the RRC connection resume procedure is initiated, the UE 102 enters an RRC-connected state.

In an embodiment of the disclosure, the service continuity controller 112 performs a cell selection when the UE 102 transitions from a RRC connected state to the RRC inactive state. The transition from the RRC connected state to the RRC inactive occurs when the network determines that the UE 102 does not need to maintain a fully active connection, but it should still be able to resume quickly. The decision to transition may be based on one or more factors, such as traffic patterns, network congestion, energy savings, network resource optimizations, and the like.

In an embodiment of the disclosure, the service continuity controller 112 determines whether the UE 102 has selected a cell different than a serving cell in which it received a RRC release message with a suspend configuration including PTM configurations for multicast session, and also determined the selected cell is a MCCH-less cell. If so, the UE 102 initiates the RRC connection resume procedure to avail the active multicast session in the RRC connected state. The active multicast session refers to an ongoing multicast service where data is transmitted to the UE 102 or a group of UEs simultaneously.

In an embodiment of the disclosure, the service continuity controller 112 determines whether the UE 102 is configured with the activated multicast session in the RRC release message received with the suspend configuration. The suspend configuration provides instructions to the UE 102 to transition to the RRC inactive state rather than going directly to the RRC idle state. The suspend configuration contains parameters and information needed by the UE 102 to properly maintain its state in RRC inactive and to ensure quick reactivation when needed.

In an embodiment of the disclosure, the service continuity controller 112 determines whether the UE 102 is configured for monitoring the PDCCH by using the G-RNTI in the RRC release message received with the suspend configuration. The G-RNTI may be included in the RRC release message to provide a global identifier for the UE 102. The UE 102 initiates the RRC connection resume procedure to receive the multicast configuration from the network apparatus. The UE 102 transitions to the RRC connected state upon initiation of the RRC connection resume procedure.

In an embodiment of the disclosure, the service continuity controller 112 determines whether the UE 102 is configured to receive an MBS multicast in the RRC inactive state. The MBS multicast allows the UE 102 to efficiently accept large-scale data broadcasts. This might be beneficial in applications that need to send the same data to several consumers at the same time. Further, the service continuity controller 112 determines whether the the UE 102 has selected or reselected a cell that is different than the cell where the multicast session was received when the UE 102 is in the RRC connected state and the selected cell or the reselected cell is a MCCH-less cell. If so, the UE 102 initiates the RRC connection resume procedure for multicast reception.

In an embodiment of the disclosure, the service continuity controller 112 determines whether the UE 102 is configured to receive a multicast in the RRC inactive state for an MBS session indicated by temporary mobile group identities (TMGIs). For instance, the TMGIs indications are provided in a group paging message. TMGIs are used to identify and group UEs that are subscribed to a particular multicast or broadcast service. This grouping enables the efficient distribution of the same data to multiple UEs simultaneously. When a multicast or broadcast session is active, the network uses TMGIs to page or notify the relevant UEs about the data being transmitted. This ensures that only the UEs subscribed to the specific multicast or broadcast service receive the relevant content.

In an embodiment of the disclosure, the service continuity controller 112 determines whether the UE 102 has selected or reselected a cell that is different than the cell where the multicast was received when the UE 102 is in the RRC connected state and the selected or reselected cell is a MCCH-less cell. If so, the UE 102 initiates the RRC connection resume procedure for multicast reception.

Referring to FIG. 1C, the UE 102 includes the processor 104, the memory 106, the I/O interface 108, and a PDCP controller 114. Each component is explained further below. The PDCP controller 114 communicates with the I/O interface 108 and the memory 106. The PDCP controller 114 may be communicatively coupled to the memory 106 and the processor 104. The PDCP controller 114 is an innovative hardware that is realized through the physical implementation of both analog and digital circuits, including logic gates, integrated circuits, microprocessors, microcontrollers, memory circuits, passive and active electronic components, as well as optical components.

In an embodiment of the disclosure, the PDCP controller 114 performs a transition to a first cell. For instance, the first cell may include at least one of a selected cell determined during a transition of the UE 102 from a RRC connected state to a RRC inactive state configured to receive a multicast session, and a reselected cell determined during a mobility of the UE 102 receiving the multicast session in the RRC inactive state. The mobility of the UE 102 refers to the ability of the UE 102 to move from one location to another while maintaining a continuous and effective connection within the wireless network.

In an embodiment of the disclosure, the PDCP controller 114 determines whether the first cell is PDCP synchronized to a source cell for an MBS multicast session or radio bearer. PDCP synchronization is crucial for ensuring that the data transmitted to or from the UE 102 remains consistent and reliable during mobility events, such as handovers, or when transitioning between different states. PDCP synchronization is essential for maintaining seamless data transmission, improving user experience, and ensuring network efficiency. The PDCP synchronization process involves context transfer, buffering, and re-establishment procedures to ensure that data sessions continue without interruption. Further, the radio bearer is designed to handle the data transmission for different types of traffic, such as voice calls, video streams, and internet data. It provides the necessary resources and protocols for transporting user data and signaling information.

In an embodiment of the disclosure, the PDCP controller 114 re-establishes a radio link control (RLC) entity and continues a pertinent packet data convergence protocol (PDCP) entity when the first cell is PDCP synchronized to the source cell for the MBS multicast session or radio bearer. The RLC entity is responsible for managing data link layer functions between the UE 102 and the network. For instance, the data link layer functions may include segmentation, retransmission, protocol data unit (PDU) transfer, and the like. The PDCP entity handles data processing and protocol management functions related to user data and signaling.

In an embodiment of the disclosure, the PDCP controller 114 establishes the RLC entity and the PDCP entity based on a new configuration received via a multicast MCCH message in the first cell. This establishment occurs when the first cell is not PDCP synchronized to the source cell for the MBS multicast session or radio bearer. The multicast MCCH message carries control information required for multicast services. It is used to manage and configure multicast sessions, including informing the UE 102 about available multicast services, scheduling, and session parameters.

In an embodiment of the disclosure, the PDCP controller 114 releases an existing multicast MBS radio bearer (MRB) and adds a new multicast MRB when the first cell is not PDCP synchronized to the source cell for the MBS multicast session. The MRB is a radio bearer used to transmit multicast data to the UE 102 or multiple UEs in the wireless network. The MRB is part of the MBS framework and plays a critical role in ensuring efficient and effective delivery of multicast content. The MRB handles data transmission, resource management, and coordination with other channels to provide a seamless multicast experience for users.

In an embodiment of the disclosure, the PDCP controller 114 receives an indicator for PDCP count synchronization of the MBS multicast session. PDCP count synchronization is a process that ensures that sequence numbers and counters used by the PDCP are correctly aligned between different network entities during handovers or transitions. This synchronization maintains a data integrity, continuity, and security as the UE 102 moves between different cells.

In an embodiment of the disclosure, the PDCP controller 114 determines whether the PDCP count of the MBS multicast session or radio bearer is synchronized within a RAN notification area (RNA). The RNA is a geographical area defined to manage and optimize signaling related to the UE 102. The RNA is useful for scenarios involving mobility and paging.

In an embodiment of the disclosure, the PDCP controller 114 performs a multicast MRB modification when the UE moves to the first cell when the PDCP count of the MBS multicast session or radio bearer is synchronized within the RNA. The multicast MRB modification refers to a process of changing the MRB configuration to adapt to changes in multicast service requirements, network conditions, or demands of the UE 102. For instance, the multicast MRB modifications may include QoS modifications, resource allocations, service changes, and the like.

In an embodiment of the disclosure, the PDCP controller 114 performs the multicast MRB modification or a release and establishment procedure when PTM configurations are updated via a multicast MCCH message in the first cell, and when the PDCP count of the MBS multicast session or radio bearer is not synchronized within the RNA.

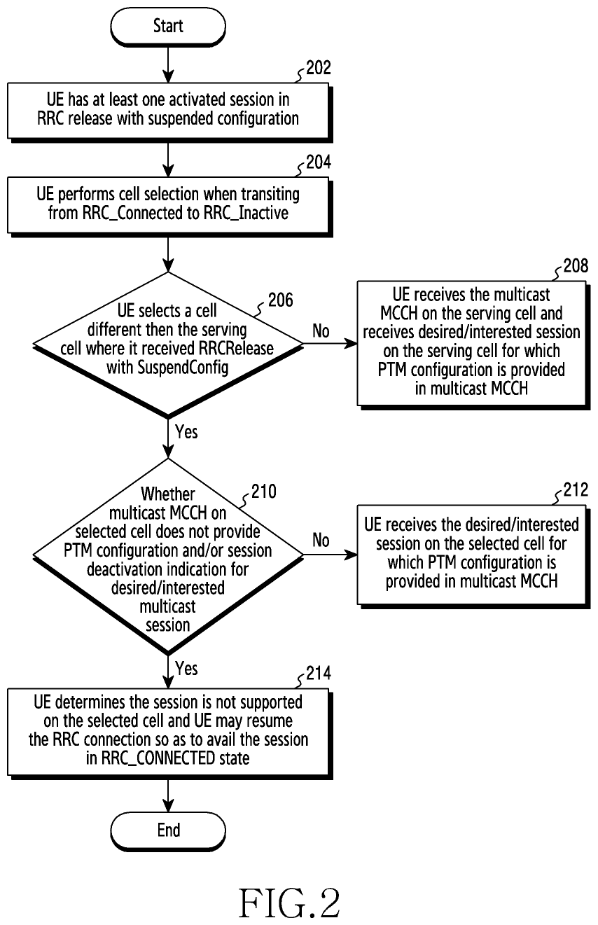

FIG. 2 is a flow diagram that illustrates a method for managing a state transition based cell selection for NR MBS multicast reception in RRC_INACTIVE state for a UE with at least one activated multicast session according to an embodiment of the disclosure.

Referring to FIG. 2, at operation 202, the UE 102 has at least one activated session in the RRC release with a suspend configuration. At operation 204, the UE 102 performs cell selection when transiting from the RRC connection state to the RRC inactive state. At operation 206, it is determined whether the UE 102 selects a cell different than the serving cell where it received the RRC release with the suspend configuration. If no, then at operation 208, the UE 102 receives the multicast MCCH on the serving cell and receives a desired/interested session on the serving cell for which the PTM configuration is provided in the multicast MCCH. If yes, then at operation 210, then it is determined whether the multicast MCCH on the selected cell does not provide the PTM configuration and/or a session deactivation indication for the desired/interested multicast session. If no, then at operation 212, the UE 102 receives the desired/interested session on the selected cell for which the PTM configuration is provided in the multicast MCCH. If yes, then at operation 214, the UE 102 determines that the session is not supported on the selected cell. The UE may then resume the RRC connection to avail the session in the RRC connected state.

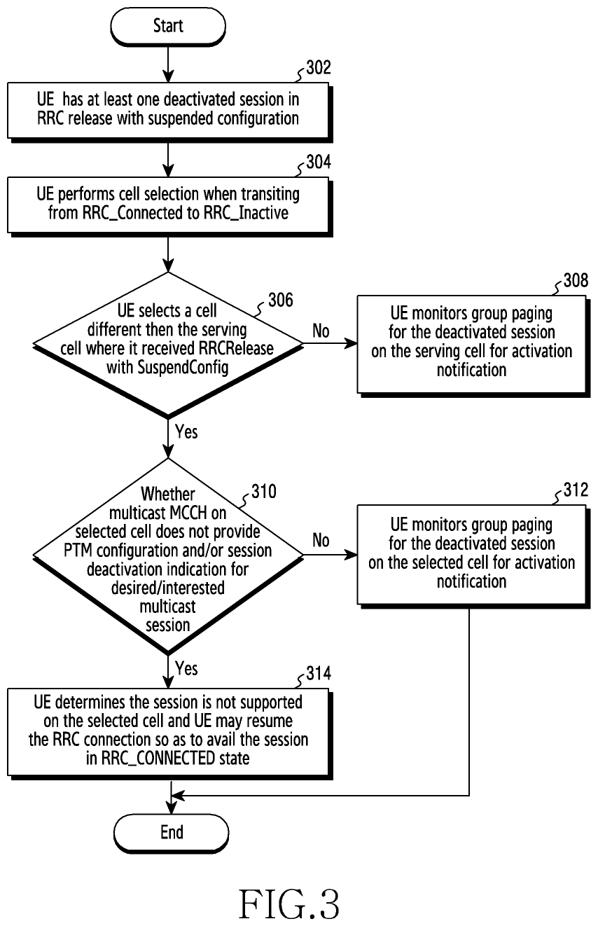

FIG. 3 is a flow diagram that illustrates a method for managing a state transition based cell selection for NR MBS multicast reception in RRC_INACTIVE state for a UE with at least one deactivated multicast session according to an embodiment of the disclosure.

Referring to FIG. 3, at operation 302, the UE 102 has at least one deactivated session in the RRC release with a suspend configuration. At operation 304, the UE 102 performs cell selection when transiting from the RRC connection state to the RRC inactive state. At operation 306, it is determined whether the UE 102 selects a cell different than the serving cell where it received the RRC release with the suspend configuration. If no, then at operation 308, the UE 102 monitors a group paging for the deactivated session on the serving cell for activation notification. If yes, then at operation 310, it is determined whether the multicast MCCH on the selected cell does not provide the PTM configuration and/or the session deactivation indication for desired/interested multicast session. If no, then at operation 312, the UE 102 monitors the group paging for the deactivated session on the selected cell for activation notification. If yes, then at operation 314, the UE 102 determines that the session is not supported on the selected cell. The UE may then resume the RRC connection to avail the session in the RRC connected state.

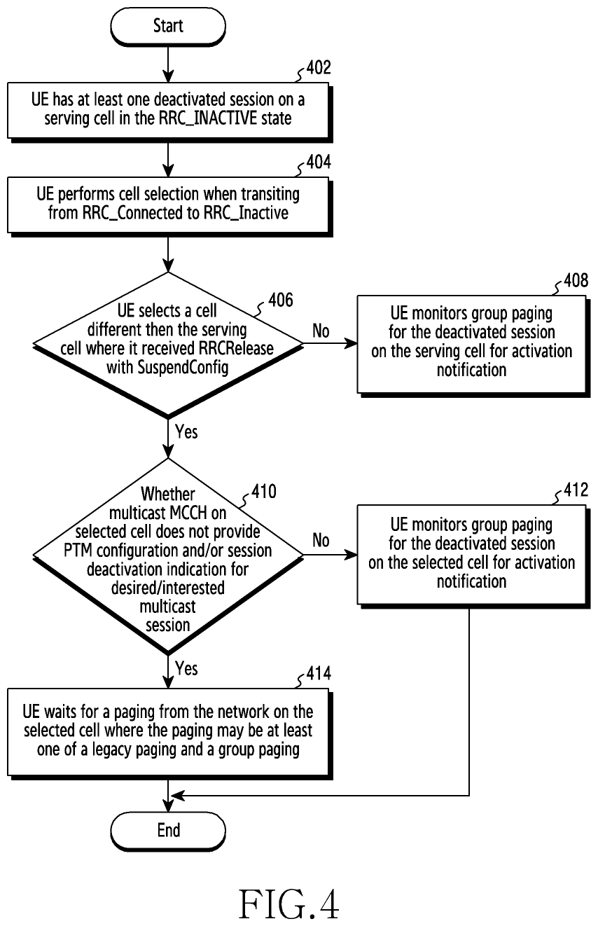

FIG. 4 is a flow diagram that illustrates a method for managing a state transition based cell selection for NR MBS multicast reception in RRC_INACTIVE state for a UE with at least one deactivated multicast session according to an embodiment of the disclosure.

Referring to FIG. 4, at operation 402, the UE 102 has at least one deactivated session in the RRC release with a suspend configuration. At operation 404, the UE 102 performs cell selection when transiting from the RRC connection state to the RRC inactive state. At operation 406, it is determined whether the UE 102 selects a cell different than the serving cell where it received the RRC release with the suspend configuration. If no, then at operation 408, the UE 102 monitors a group paging for the deactivated session on the serving cell for activation notification. If yes, then at operation 410, it is determined whether the multicast MCCH on the selected cell does not provide the PTM configuration and/or the session deactivation indication for desired/interested multicast session. If no, then at operation 412, the UE 102 monitors the group paging for the deactivated session on the selected cell for activation notification. If yes, then at operation 414, the UE 102 waits for a paging from the network on the selected cell. For instance, the paging may be at least one of a legacy paging and a group paging.

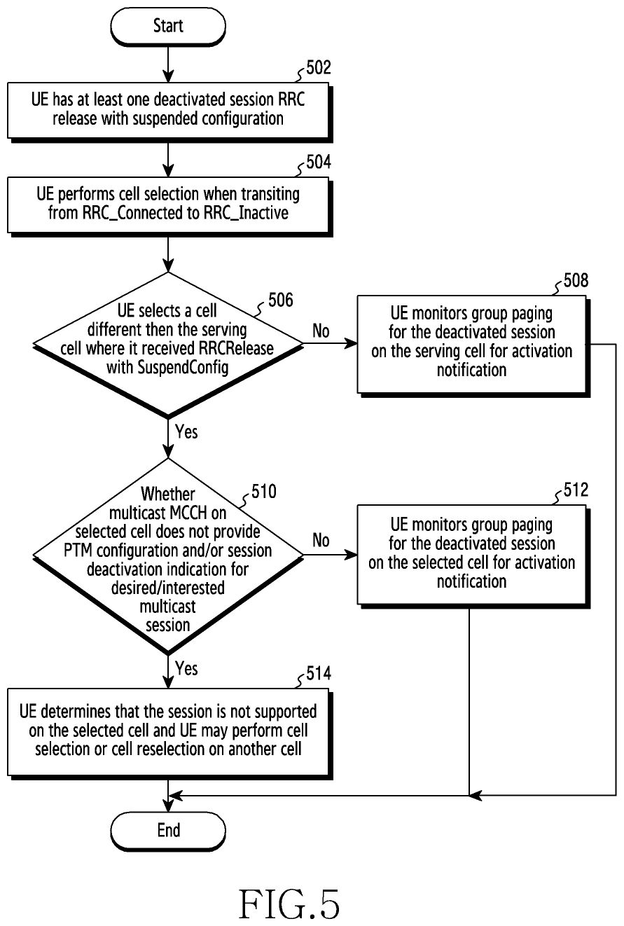

FIG. 5 is a flow diagram that illustrates a method for managing a state transition based cell selection for NR MBS multicast reception in RRC_INACTIVE state for a UE with at least one deactivated multicast session according to an embodiment of the disclosure.

Referring to FIG. 5, at operation 502, the UE 102 has at least one deactivated session in the RRC release with a suspend configuration. At operation 504, the UE 102 performs cell selection when transiting from the RRC connection state to the RRC inactive state. At operation 506, it is determined whether the UE 102 selects a cell different than the serving cell where it received the RRC release with the suspend configuration. If no, then at operation 508, the UE 102 monitors a group paging for the deactivated session on the serving cell for activation notification. If yes, then at operation 510, it is determined whether the multicast MCCH on the selected cell does not provide the PTM configuration and/or the session deactivation indication for desired/interested multicast session. If no, then at operation 512, the UE 102 monitors the group paging for the deactivated session on the selected cell for activation notification. If yes, then at operation 514, the UE 102 determines that the session is not supported on the selected cell. The UE 102 may then perform cell selection or cell reselection on another cell.

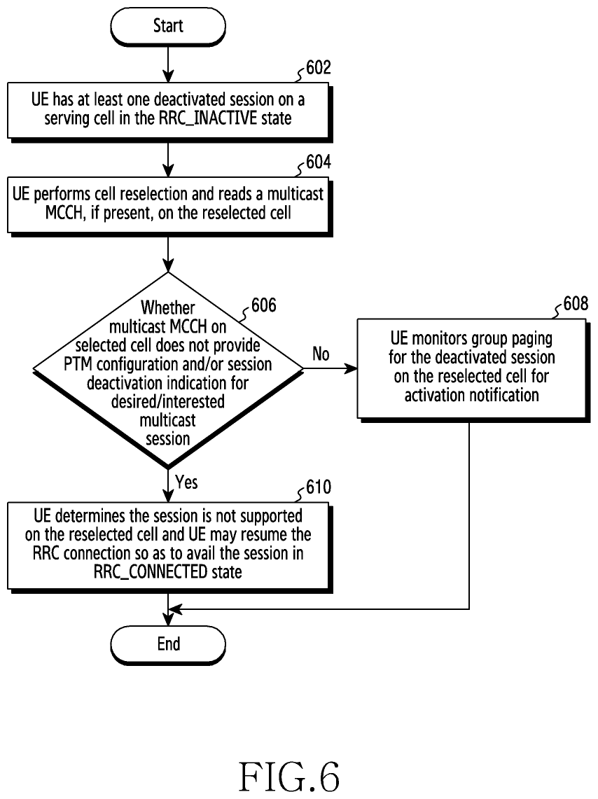

FIG. 6 is a flow diagram that illustrates a method for managing a cell reselection for NR MBS multicast reception in RRC_INACTIVE state for a UE with at least one deactivated multicast session according to an embodiment of the disclosure.

Referring to FIG. 6, at operation 602, the UE 102 has at least one deactivated session on a serving cell in the RRC_INACTIVE state. At operation 604, the UE 102 performs a cell reselection and reads a multicast MCCH, if present, on the reselected cell. At operation 606, it is determined whether the multicast MCCH on the selected cell does not provide the PTM configuration and/or the session deactivation indication for the desired/interested multicast session. If no, then at operation 608, the UE 102 monitors a group paging for the deactivated session on the reselected cell for activation notification. If yes, then at operation 610, the UE 102 determines that the session is not supported on the reselected cell. The UE may resume the RRC connection to avail the session in RRC_CONNECTED state.

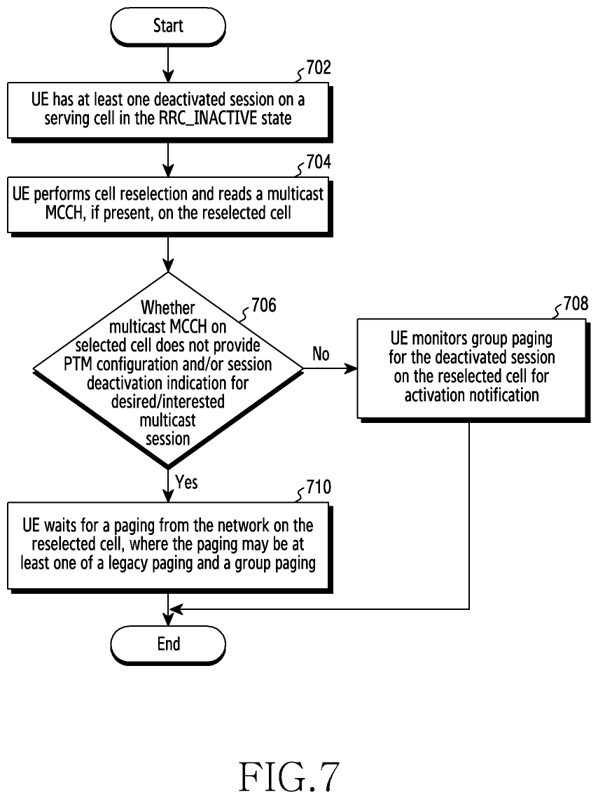

FIG. 7 is a flow diagram that illustrates a method for managing a cell reselection for NR MBS multicast reception in RRC_INACTIVE state for a UE 102 with at least one deactivated multicast session according to an embodiment of the disclosure.

Referring to FIG. 7, at operation 702, the UE 102 has at least one deactivated session on a serving cell in the RRC_INACTIVE state. At operation 704, the UE 102 performs a cell reselection and reads a multicast MCCH, if present, on the reselected cell. At operation 706, it is determined whether the multicast MCCH on the selected cell does not provide the PTM configuration and/or the session deactivation indication for the desired/interested multicast session. If no, then at operation 708, the UE 102 monitors a group paging for the deactivated session on the reselected cell for activation notification. If yes, then at operation 710, the UE 102 waits for a paging from the network on the reselected cell. The paging may be at least one of a legacy paging and a group paging.

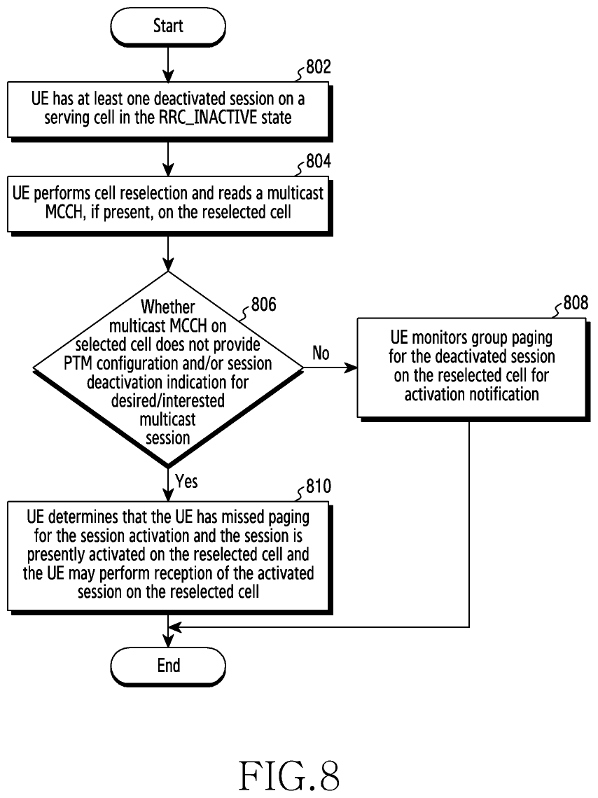

FIG. 8 is a flow diagram that illustrates a method for managing a cell reselection for NR MBS multicast reception in RRC_INACTIVE state for a UE 102 with at least one deactivated multicast session according to an embodiment of the disclosure.

Referring to FIG. 8, at operation 802, the UE 102 has at least one deactivated session on a serving cell in the RRC_INACTIVE state. At operation 804, the UE 102 performs a cell reselection and reads a multicast MCCH, if present, on the reselected cell. At operation 806, it is determined whether the multicast MCCH on the selected cell does not provide the PTM configuration and/or the session deactivation indication for the desired/interested multicast session. If no, then at operation 808, the UE 102 monitors a group paging for the deactivated session on the reselected cell for activation notification. If yes, then at operation 810, the UE 102 determines that it has a missed paging for the session activation and the session is presently activated on the reselected cell. The UE 102 may perform reception of the activated session on the reselected cell.

In an embodiment of the disclosure, during RRC state transition (for example, from RRC_CONNECTED state to RRC_INACTIVE state), if the UE 102 selects a cell different than the serving cell for which the UE 102 received the RRCRelease with SuspendConfig including PTM configurations and/or deactivation indications, the UE 102 discards the stored, if any, PTM configurations that were received on the serving cell (for example, received through RRCRelease with SuspendConfig message. The UE 102 obtains the PTM configurations from the selected cell over multicast MCCH, if present, for the same set of sessions that were configured on the serving cell using RRCRelease with SuspendConfig, and stores them.

In an embodiment of the disclosure, if the UE 102 selects the same cell as the serving cell for which the UE 102 got the RRCRelease with SuspendConfig, the UE 102 maintains the stored, if any, PTM configurations received on the serving cell and does not acquire multicast MCCH. The UE 102 can monitor the downlink control information (DCI) for the multicast MCCH change notification. If the multicast MCCH change notification indicates a change of multicast MCCH, the UE 102 acquires the multicast MCCH from the same slot from which it got the multicast MCCH change notification. Further, the UE 102 reads the PTM configurations and/or deactivation indications from the multicast MCCH only for multicast sessions that were configured/signalled in the RRCRelease with SuspendConfig for the UE 102.

In an embodiment of the disclosure, during RRC state transition (e.g., from RRC_CONNECTED state to RRC_INACTIVE state) if the UE 102 selects a cell different than the serving cell for which the UE 102 received the RRCRelease with SuspendConfig including PTM configurations and/or deactivation indications, and the UE 102 has received at least one activated session in the RRCRelease with SuspendConfig, the UE 102 may read the multicast MCCH, if present, on the selected cell and if the multicast MCCH on the selected cell does not provide the PTM configuration and/or session deactivation indication for the desired/interested multicast session, the UE 102 determines the session is not supported on the selected cell and the UE 102 may resume the RRC connection so as to avail the session in RRC_CONNECTED state.

In an embodiment of the disclosure, during RRC state transition (e.g., from RRC_CONNECTED state to RRC_INACTIVE state) if the UE 102 selects a cell different than the serving cell for which the UE 102 received the RRCRelease with SuspendConfig including PTM configurations and/or deactivation indications, and the UE 102 has received at least one activated session in the RRCRelease with SuspendConfig, the UE 102 may read the multicast MCCH, if present, on the selected cell and if the multicast MCCH on the selected cell does not provide the PTM configuration and/or session deactivation indication for the desired/interested multicast session, the UE 102 determines the session is not supported on the selected cell and the UE 102 may perform cell selection/reselection to another cell.

In an embodiment of the disclosure, during RRC state transition (e.g., from RRC_CONNECTED state to RRC_INACTIVE state) if the UE 102 selects a cell different than the serving cell for which the UE 102 received the RRCRelease with SuspendConfig including PTM configurations and/or deactivation indications, and the UE 102 has received at least one deactivated session in the RRCRelease with SuspendConfig, the UE 102 may read the multicast MCCH, if present, on the selected cell and if the multicast MCCH on the selected cell does not provide the PTM configuration and/or deactivation indication for the desired/interested multicast session, the UE 102 determines the session is not supported on the selected cell and the UE 102 may resume the RRC connection so as to avail the session in RRC_CONNECTED state.

In an embodiment of the disclosure, during RRC state transition (e.g., from RRC_CONNECTED state to RRC_INACTIVE state) if the UE 102 selects a cell different than the serving cell for which the UE 102 received the RRCRelease with SuspendConfig including PTM configurations and/or deactivation indications, and the UE 102 has received at least one deactivated session in the RRCRelease with SuspendConfig, the UE 102 may read the multicast MCCH, if present, on the selected cell and if the multicast MCCH on the selected cell does not provide the PTM configuration and/or deactivation indication for the desired/interested multicast session, the UE 102 may wait for paging from the network on the selected cell. The paging may be at least one of a legacy paging (i.e., unicast paging) and a group paging.

In an embodiment of the disclosure, during RRC state transition (e.g., from RRC_CONNECTED state to RRC_INACTIVE state) if the UE 102 selects a cell different than the serving cell for which the UE 102 received the RRCRelease with SuspendConfig including PTM configurations and/or deactivation indications, and the UE 102 has received at least one deactivated session in the RRCRelease with SuspendConfig, the UE 102 may read the multicast MCCH, if present, on the selected cell and if the multicast MCCH on the selected cell does not provide the PTM configuration and/or deactivation indication for the desired/interested multicast session, the UE 102 determines the session is not supported on the selected cell and the UE 102 may perform cell selection/reselection to another cell.

In an embodiment of the disclosure, if the UE 102 has at least one activated session on the serving cell for multicast reception in RRC_INACTIVE state and the UE 102 performs cell reselection, the UE 102 may read the multicast MCCH, if present, on the reselected cell and if the multicast MCCH on the reselected cell does not provide the PTM configuration and/or deactivation indication for the desired/interested multicast session, the UE 102 determines the session is not supported on the reselected cell and the UE 102 may resume the RRC connection so as to avail the session in RRC_CONNECTED state.

In an embodiment of the disclosure, if the UE 102 has at least one deactivated session on the serving cell for multicast reception in RRC_INACTIVE state and the UE 102 performs cell reselection, the UE 102 may read the multicast MCCH, if present, on the reselected cell and if the multicast MCCH on the reselected cell does not provide the PTM configuration and/or for the desired/interested multicast session, the UE 102 determines the session is not supported on the reselected cell and the UE 102 may resume the RRC connection so as to avail the session in RRC_CONNECTED state.

In an embodiment of the disclosure, if the UE 102 has at least one deactivated session on the serving cell for multicast reception in RRC_INACTIVE state and the UE 102 performs cell reselection, the UE 102 may read the multicast MCCH, if present, on the reselected cell and if the multicast MCCH on the reselected cell does not provide the PTM configuration and/or session deactivation indication for the desired/interested multicast session, the UE 102 may wait for paging from the network on the reselected cell. The paging may be at least one of a legacy paging (i.e., unicast paging) and a group paging.

In an embodiment of the disclosure, if the UE 102 has at least one deactivated session on the serving cell for multicast reception in RRC_INACTIVE state and the UE 102 performs cell reselection, the UE 102 may read the multicast MCCH, if present, on the reselected cell and if the multicast MCCH on the reselected cell does not provide the PTM configuration and/or session deactivation indication for the desired/interested multicast session, the UE 102 determines the session is not supported on the reselected cell and the UE 102 may perform cell reselection to another cell.

In an embodiment of the disclosure, if the UE 102 has at least one deactivated session on the serving cell for multicast reception in RRC_INACTIVE state and UE performs cell reselection, the UE 102 may read the multicast MCCH, if present, on the reselected cell and if the multicast MCCH on the reselected cell provides the PTM configuration but no session deactivation indication for the desired/interested multicast session, the UE 102 determines that the UE 102 may have missed paging for the session activation and the session is presently activated on the reselected cell and the UE 102 may perform reception of the activated session on the reselected cell.

In an embodiment of the disclosure, if the UE 102 has at least one activated session and/or at least one deactivated session on the serving cell for multicast reception in RRC_INACTIVE state and the UE 102 performs cell reselection, the UE 102 may read the multicast MCCH, if present, on the reselected cell. If the multicast MCCH on the reselected cell provides session deactivation indication for the desired/interested multicast session, the UE 102 starts monitoring for group paging for the deactivated session on the reselected cell.

In an embodiment of the disclosure, the UE 102 may be provided by the network in at least one of the dedicated signaling (for example, RRC reconfiguration message, RRC Release message, RRCRelease with SuspendConfig message) and/or broadcast signaling (for example, system information block (SIB) or multicast MCCH) frequency priority for the multicast reception in the RRC_INACTIVE state.

In an embodiment of the disclosure, the frequency priority for the multicast reception in the RRC_INACTIVE state is commonly provided for all the multicast sessions configured for the UE 102 (for example, in RRCRelease with SuspendConfig message and/or multicast MCCH message).

In an embodiment of the disclosure, the frequency priority for the multicast reception in the RRC_INACTIVE state is specifically provided for one or more sessions (for example, in RRCRelease with SuspendConfig message and/or multicast MCCH message), i.e., there is a mapping information for the frequency priority for multicast reception in RRC_INACTIVE state and multicast session(s), and accordingly the UE may use the frequency priority information for the relevant multicast sessions.

In an embodiment of the disclosure, the frequency priority information for multicast reception in RRC_INACTIVE state which is received by the UE 102 in the RRCRelease with SuspendConfig message is overridden by the frequency priority information in the latest multicast MCCH message received in the RRC_INACTIVE state for the configured activated and/or deactivated sessions for the UE 102.

In an embodiment of the disclosure, when the UE 102 performs cell selection or reselection to another cell than the serving cell where it had received the frequency priority information for multicast reception in RRC_INACTIVE state, the UE 102 acquires the frequency priority information from the multicast MCCH, if present, on the selected/reselected cell for the configured activated and/or deactivated sessions for the UE 102.

In an embodiment of the disclosure, the frequency priority information for multicast reception in RRC_INACTIVE state is provided to the UE 102 only in the RRCRelease with SuspendConfig message. For example, multicast MCCH message does not carry the frequency priority information for multicast reception in RRC_INACTIVE state.

In an embodiment of the disclosure, the frequency priority information for multicast reception in RRC_INACTIVE state is provided to the UE 102 in the RRCRelease with SuspendConfig message is valid until the expiry of timer T320. Upon expiry of T320, the UE 102 may resume the RRC connection so as to avail the latest frequency priority information for multicast reception.

In an embodiment of the disclosure, the UEs which are supporting 3GPP Release 18 MBS may be capable and/or configured to receive multicast in RRC_INACTIVE state whereas the UEs pertaining to previous release (i.e., 3GPP Release 17 MBS) may not be capable and/or not configured to receive multicast in an RRC_INACTIVE state. Co-existence of these two sets of UEs in the same cell/network is feasible and needs to be supported. Further, there is a need for mechanism which ensures the multicast service continuity in the RRC_INACTIVE state along with the mobility of the UEs.

In an embodiment of the disclosure, the approach for PDCP sync operation in conjunction with the MCCH neighbour cell information broadcasted in the cell is specified.

In an embodiment of the disclosure, 1-bit PDCP sync indication (for example, in the RRCRelease with SuspendConfig message and/or multicast MCCH message wherein the indication may be provided per MBS multicast service or session) indicates that the same multicast service is synchronized within the RNA i.e., the cells comprising the RNA have the synchronized transmission of the same multicast service e.g., packet sequence number (e.g., PDCP COUNT) based synchronization. In addition, a neighboring cell list (NCL) in the RRCRelease with SuspendConfig message and/or multicast MCCH message specifies that the same multicast service is provided in the indicated neighbor cell(s) among the neighbor cell(s) included in the NCL. An issue would be about the confusion that PDCP sync is indicated but NCL indicates that a neighbor cell within the RNA does not provide the same service. The issue is addressed as follows:

### Approach A1: PDCP Synchronization Includes the Service Availability

PDCP synchronization could be a sufficient condition of temporary mobile group identity (TMGI)-level service continuity.

If PDCP synchronization within the RNA is indicated, UE assumes that the same service is provided by all cells within the RNA.

### Approach A2: PDCP Synchronization is Independent of Service Availability

PDCP synchronization bit indicates that PDCP COUNT is synced in the cell for which NCL indicates that the same service is provided. E.g., if NCL indicates that the service is not provided in a cell of the same RNA, the cell does not provide the multicast service even though the cell is part of the RNA.

In an embodiment of the disclosure, if there is no NCL information present and/or empty NCL information is signaled and/or the selected/reselected neighbor cell is not present in NCL for the multicast session and/or it cannot be interpreted about the multicast service availability for the selected/reselected neighbor cell from the received NCL information, the UE 102 determines the PDCP synchronization includes the service continuity. For example, if the PDCP synchronization within the RNA is indicated, the UE 102 assumes that the same service is provided by all cells within the RNA.

In an embodiment of the disclosure, if there is no NCL information present and/or empty NCL information is signaled and/or the selected/reselected neighbor cell is not present in NCL for the multicast session and/or it cannot be interpreted about the multicast service availability for the selected/reselected neighbor cell from the received NCL information, the UE 102 determines that the neighbor cell does not provide the multicast service even though PDCP synchronization bit indicates that PDCP COUNT is synced in the cell and the cell is part of the RNA.

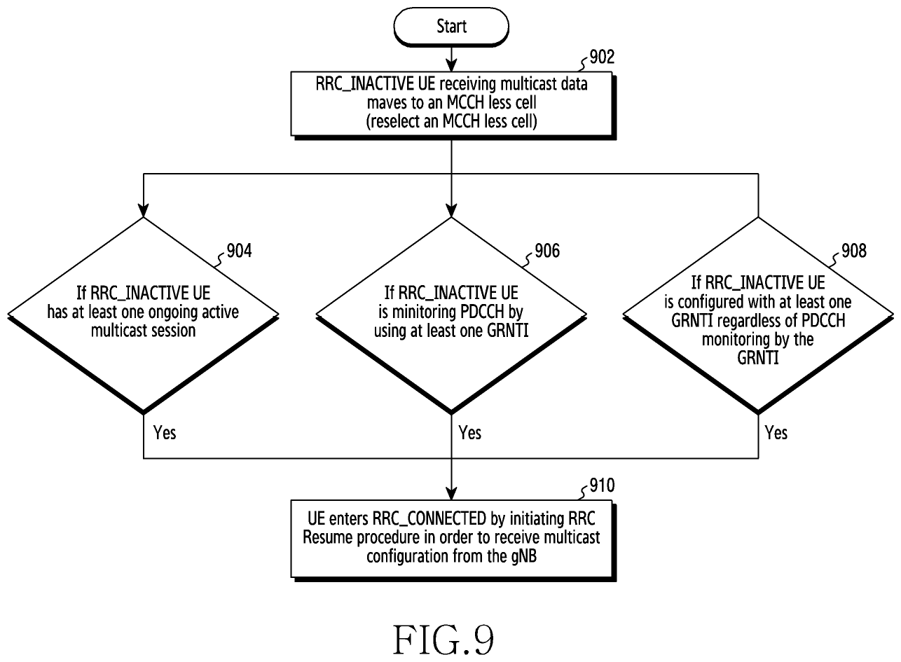

FIG. 9 is a flow diagram that illustrates a method for managing a service continuity for NR MBS multicast reception in RRC_INACTIVE state for a UE moving to a multicast MCCH-less cell according to an embodiment of the disclosure.

In an embodiment of the disclosure, the mobility of the UE 102 to a MCCH-less cell is addressed. If the MCCH message is not broadcasted (MCCH configuration is missing in SIBx) but the new SIB (SIBx) is broadcasted in the cell, it is an MCCH-less cell providing multicast service for RRC_INACTIVE UEs. Since the MCCH-less cell does not broadcast multicast-related configurations, the UE 102 behavior at re-selecting an MCCH-less cell needs to be specified.

### Approach 1:

Referring to FIG. 9, at operation 902, if the RRC_INACTIVE UE 102 receiving the multicast data moves to an MCCH-less cell (reselect an MCCH-less cell), UE may enter the RRC_CONNECTED state by initiating the RRC connection resume procedure.

1a) At operation 904, if the RRC_INACTIVE UE 102 has at least one ongoing active multicast session, then at operation 910, the UE 102 may enter the RRC_CONNECTED state by initiating the RRC connection resume procedure in order to receive multicast configuration from the gNB.

1b) At operation 906, if the RRC_INACTIVE UE 102 is monitoring the PDCCH by using at least one G-RNTI, then at operation 910, the UE 102 may enter the RRC_CONNECTED state by initiating the RRC connection resume procedure in order to receive a multicast configuration from the gNB.

1c) At operation 908, if the RRC_INACTIVE UE 102 is configured with at least one G-RNTI regardless of PDCCH monitoring by the G-RNTI (i.e., irrespective of activated or deactivated session), then at operation 910, the UE 102 may enter the RRC_CONNECTED state by initiating the RRC connection resume procedure in order to receive multicast configuration from the gNB.

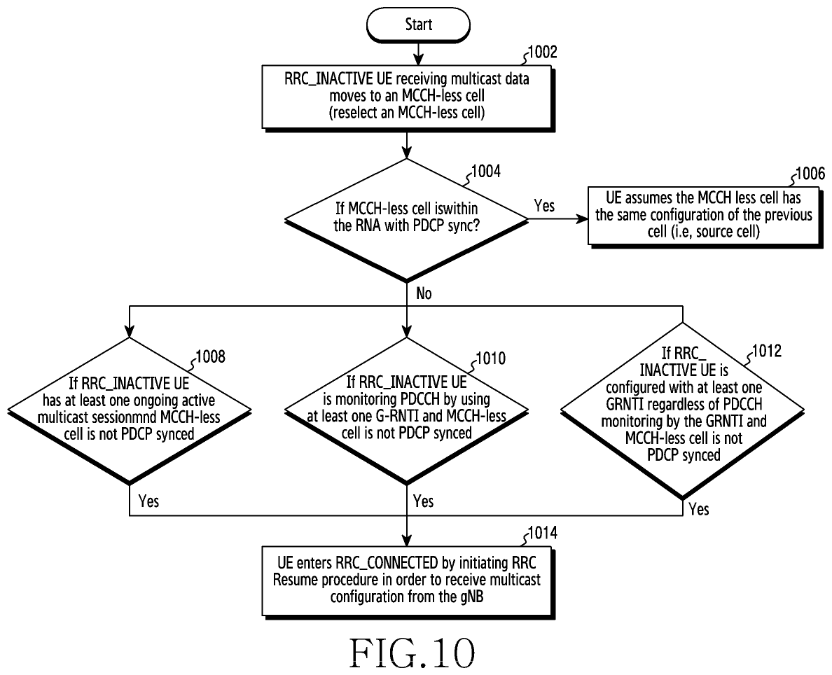

FIG. 10 is a flow diagram that illustrates a method for managing a service continuity for NR MBS multicast reception in RRC_INACTIVE state for a UE moving to a multicast MCCH-less cell in conjunction with a PDCP synchronization indicator according to an embodiment of the disclosure.

### Approach 2:

Referring to FIG. 10, at operation 1002, the RRC_INACTIVE UE 102 receiving multicast data moves to an MCCH-less cell (reselect an MCCH-less cell). At operation 1004, if the RRC_INACTIVE UE 102 receiving multicast data moves to an MCCH-less cell (reselect an MCCH-less cell) within the RNA with PDCP sync, then at operation 1006, the UE 102 assumes the MCCH-less cell has the same configuration of the previous cell (i.e., a source cell).

2a) At operation 1008, if the RRC_INACTIVE UE 102 has at least one ongoing active multicast session and MCCH-less cell is not PDCP synced, then at operation 1014, the UE 102 may enter RRC_CONNECTED by initiating RRC connection resume procedure in order to receive multicast configuration from the gNB.

2b) At operation 1010, if the RRC_INACTIVE UE 102 is monitoring PDCCH by using at least one G-RNTI and MCCH-less cell is not PDCP synced, then at operation 1014, the UE 102 may enter RRC_CONNECTED by initiating RRC connection resume procedure in order to receive multicast configuration from the gNB.

2c) At operation 1012, if the RRC_INACTIVE UE 102 is configured with at least one G-RNTI regardless of PDCCH monitoring by the G-RNTI (i.e., irrespective of activated or deactivated session) and MCCH-less cell is not PDCP synced, then at operation 1014, the UE 102 may enter RRC_CONNECTED by initiating RRC connection resume procedure in order to receive multicast configuration from the gNB.

In an embodiment of the disclosure, when the UE 102 moves to a PDCP synced MCCH-less cell, the UE 102 continuously receives the multicast data.

In an embodiment of the disclosure, the inactive G-RNTI (G-RNTI monitoring is deactivated by MCCH in the previous cell) can be activated, since the MCCH-less cell does not support G-RNTI deactivation).

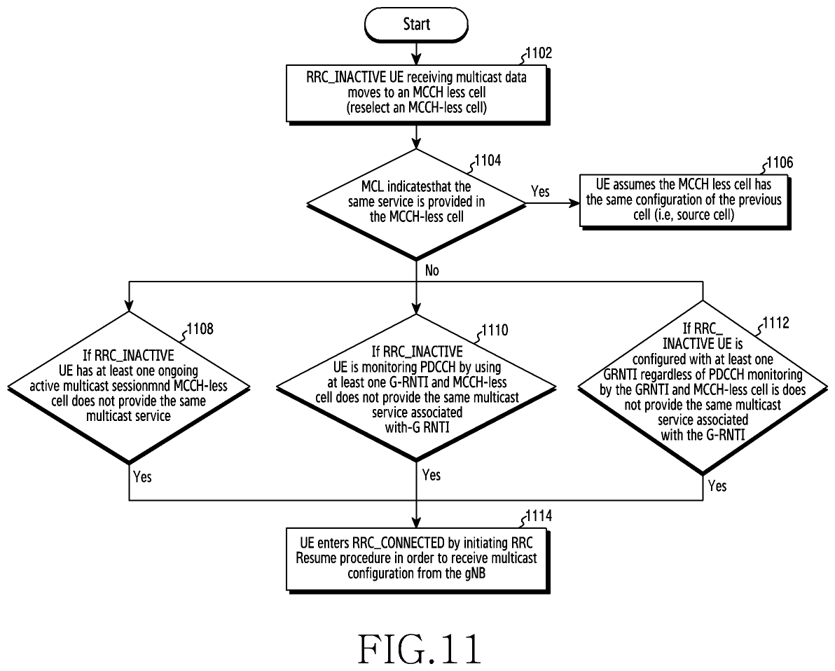

FIG. 11 is a flow diagram that illustrates a method for managing a service continuity for NR MBS multicast reception in RRC_INACTIVE state for a UE moving to a multicast MCCH-less cell in conjunction with a neighbor cell list (NCL) according to an embodiment of the disclosure.

### Approach 3:

Referring to FIG. 11, at operation 1102, the RRC_INACTIVE UE 102 receiving multicast data moves to an MCCH-less cell (reselect an MCCH-less cell). At operation 1104, if the RRC_INACTIVE UE 102 receiving multicast data moves to an MCCH-less cell (reselect an MCCH-less cell) indicated by NCL that the same service is provided, then at operation 1106, the UE 102 assumes the MCCH-less cell has the same configuration of the previous cell.

3a) At operation 1108, if the RRC_INACTIVE UE 102 has at least one ongoing active multicast session and MCCH-less cell does not provide the same multicast service, then at operation 1114, the UE 102 may enter RRC_CONNECTED by initiating RRC connection resume procedure in order to receive multicast configuration from the gNB.

3b) At operation 1110, if the RRC_INACTIVE UE 102 is monitoring PDCCH by using at least one G-RNTI and MCCH-less cell does not provide the same multicast service associated with G-RNTI, then at operation 1114, the UE 102 may enter RRC_CONNECTED by initiating RRC connection resume procedure in order to receive multicast configuration from the gNB.

3c) At operation 1112, if the RRC_INACTIVE UE 102 is configured with at least one G-RNTI regardless of PDCCH monitoring by the G-RNTI (i.e., irrespective of activated or deactivated session) and MCCH-less cell does not provide the same multicast service associated with G-RNTI, then at operation 1114, the UE 102 may enter RRC_CONNECTED by initiating RRC connection resume procedure in order to receive multicast configuration from the gNB.

In an embodiment of the disclosure, when the UE 102 moves to a MCCH-less cell providing the same service, the UE 102 continuously receives the multicast data.

In an embodiment of the disclosure, the inactive G-RNTI (G-RNTI monitoring is deactivated by MCCH in the previous cell) can be activated, since the MCCH-less cell does not support G-RNTI deactivation)

For Approach 2 and Approach 3, the UE 102 stays in RRC_INACTIVE only if all the ongoing services are continued. Otherwise, the UE 102 enters RRC_CONNECTED.

In an embodiment of the disclosure, for approach 1, approach 2 and approach 3, the UE 102 may perform cell reselection to another cell (for example, reselecting another MCCH cell in the RNA, instead of moving to RRC_CONNECTED) in order to avail multicast configuration and/or session from gNB.

In an embodiment of the disclosure, during RRC state transition (for example, from RRC_CONNECTED state to RRC_INACTIVE state) if the UE 102 selects a cell different than the serving cell for which the UE 102 received the RRCRelease with SuspendConfig including PTM configurations and/or deactivation indications, and the selected cell is MCCH-less cell, the UE 102 determines the session is not supported on the selected cell. The UE 102 may resume the RRC connection so as to avail the session in RRC_CONNECTED state.

### Approach 4:

4a) If the UE 102 is configured with at least one activated multicast session in the RRCRelease with SuspendConfig, the UE 102 may enter RRC_CONNECTED by initiating RRC connection resume procedure in the selected cell in order to receive multicast configuration from the gNB.

4b) If the UE 102 is configured for monitoring PDCCH by using at least one G-RNTI in the RRCRelease with SuspendConfig, the UE 102 may enter RRC_CONNECTED by initiating RRC connection resume procedure in order to receive multicast configuration from the gNB.

4c) If the UE 102 is configured with at least one G-RNTI regardless of PDCCH monitoring by the G-RNTI (i.e., irrespective of activated or deactivated session) in the RRCRelease with SuspendConfig, the UE 102 may enter RRC_CONNECTED by initiating RRC connection resume procedure in the selected cell in order to receive multicast configuration from the gNB.

In an embodiment of the disclosure, during RRC state transition (for example, from RRC_CONNECTED state to RRC_INACTIVE state) if the UE 102 selects a cell different than the serving cell for which the UE 102 received the RRCRelease with SuspendConfig including PTM configurations and/or deactivation indications, and the selected cell is MCCH-less cell, the UE 102 determines the session is not supported on the selected cell and the UE 102 may perform cell selection/reselection to another cell (for example, MCCH cell in the RNA) so as to avail multicast service.

### Approach 5:

5a) If the UE 102 is configured with at least one activated multicast session in the RRCRelease with SuspendConfig, the UE 102 may perform cell selection/reselection to another cell in order to receive multicast configuration from the gNB.

5b) If the UE 102 is configured for monitoring PDCCH by using at least one G-RNTI in the RRCRelease with SuspendConfig, the UE 102 may perform cell selection/reselection to another cell in order to receive multicast configuration from the gNB.

5c) If the UE 102 is configured with at least one G-RNTI regardless of PDCCH monitoring by the G-RNTI (i.e., irrespective of activated or deactivated session) in the RRCRelease with SuspendConfig, the UE 102 may perform cell selection/reselection to another cell in order to receive multicast configuration from the gNB.

In an embodiment of the disclosure, during RRC state transition (for example, from RRC_CONNECTED state to RRC_INACTIVE state) if the UE 102 selects a cell different than the serving cell for which the UE 102 received the RRCRelease with SuspendConfig including PTM configurations and/or deactivation indications, and the selected cell is MCCH-less cell within the RNA with PDCP sync (the UE 102 determines the PDCP sync status from the PDCP sync indicator field for the MBS session), the UE 102 assumes the MCCH-less cell has the same configuration of the previous cell (i.e., source cell).

### Approach 6:

6a) If the UE 102 is configured with at least one activated multicast session the RRCRelease with SuspendConfig and MCCH-less cell is not PDCP synced, the UE 102 may enter RRC_CONNECTED by initiating RRC connection resume procedure in order to receive multicast configuration from the gNB.

6b) If the UE 102 is configured for monitoring PDCCH by using at least one G-RNTI in the RRCRelease with SuspendConfig and MCCH-less cell is not PDCP synced, the UE 102 may enter RRC_CONNECTED by initiating RRC connection resume procedure in order to receive multicast configuration from the gNB.

6c) If the UE 102 is configured with at least one G-RNTI regardless of PDCCH monitoring by the G-RNTI (i.e., irrespective of activated or deactivated session) in the RRCRelease with SuspendConfig and MCCH-less cell is not PDCP synced, the UE 102 may enter RRC_CONNECTED by initiating RRC connection resume procedure in order to receive multicast configuration from the gNB.

In an embodiment of the disclosure, during RRC state transition (for example, from RRC_CONNECTED state to RRC_INACTIVE state) if the UE 102 selects a cell different than the serving cell for which the UE 102 received the RRCRelease with SuspendConfig including PTM configurations and/or deactivation indications, and selected cell is an MCCH-less cell) indicated by NCL that the same service is provided (e.g., in the RRCRelease with SuspendConfig message), the UE 102 assumes the MCCH-less cell has the same configuration of the previous cell.

### Approach 7:

7a) If the UE 102 is configured with at least one activated multicast session in the RRCRelease with SuspendConfig and MCCH-less cell does not provide the same multicast service, the UE 102 may enter RRC_CONNECTED by initiating RRC connection resume procedure in order to receive multicast configuration from the gNB.

7b) If the UE 102 is configured for monitoring PDCCH by using at least one G-RNTI in the RRCRelease with SuspendConfig and MCCH-less cell does not provide the same multicast service associated with G-RNTI, the UE 102 may enter RRC_CONNECTED by initiating RRC connection resume procedure in order to receive multicast configuration from the gNB.

7c) If the UE 102 is configured with at least one G-RNTI regardless of PDCCH monitoring by the G-RNTI (i.e., irrespective of activated or deactivated session) in the RRCRelease with SuspendConfig and MCCH-less cell does not provide the same multicast service associated with G-RNTI, the UE 102 may enter RRC_CONNECTED by initiating RRC connection resume procedure in order to receive multicast configuration from the gNB.

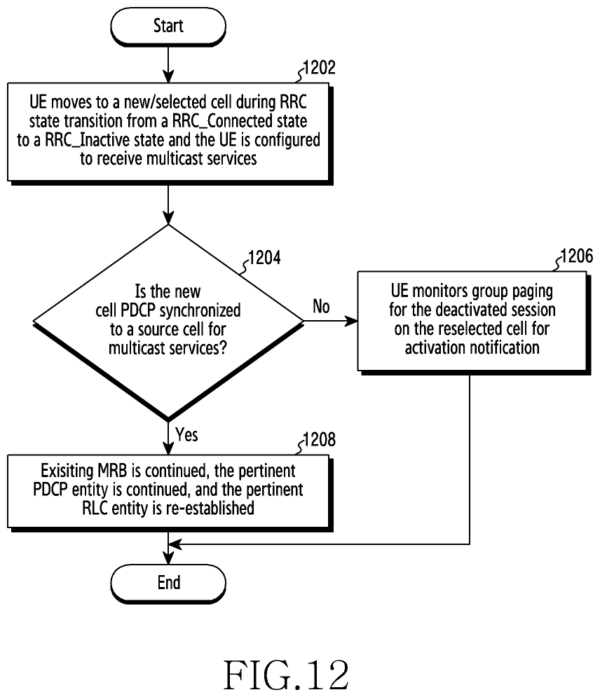

FIG. 12 is a flow diagram that illustrates a method for managing PDCP synchronization for NR MBS multicast reception in RRC_INACTIVE state during mobility across cells according to an embodiment of the disclosure.

Referring to FIG. 12, at operation 1202, the UE 102 moves to a new/selected cell during RRC state transition from a RRC connected state to a RRC inactive state. The UE 102 is configured to receive multicast services. At operation 1204, it is determined whether the new cell is PDCP synchronized to a source cell for multicast services. If no, then at operation 1206, an existing MRB is released, a new MRB is established, and a pertinent PDCP entity or pertinent RLC entity is established. These establishments are based on a new configuration received via a multicast MCCH message in the new cell. If yes, then at operation 1208, the existing MRB is continued, the pertinent PDCP entity is continued, and the pertinent RLC entity is re-established.

In an embodiment of the disclosure, if there is no NCL information present and/or empty NCL information is signaled and/or the selected/reselected neighbor cell is not present in NCL for the multicast session and/or it cannot be interpreted about the multicast service availability for the selected/reselected neighbor cell from the received NCL information, the UE 102 determines that the neighbor cell does not provide the multicast service even though PDCP synchronization bit indicates that PDCP COUNT is synced in the cell and the cell is part of the RNA.

In an embodiment of the disclosure, the UE 102 mobility to a MCCH-less cell is addressed. If the MCCH message is not broadcasted (MCCH configuration is missing in SIBx) but the new SIB (SIBx) is broadcasted in the cell, it is an MCCH-less cell providing multicast service for RRC_INACTIVE UEs. Since the MCCH-less cell does not broadcast multicast-related configurations, UE behavior at re-selecting an MCCH-less cell needs to be specified.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP synced to the source (previous) cell for an MBS multicast service, pertinent PDCP entity is continued and pertinent RLC entity is re-established. In this scenario, one-to-one mapping for PDCP packet and RLC packet may not be guaranteed across cells and hence, RLC entity re-establishment is pursued.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP synced to the source (previous) cell for an MBS multicast service, pertinent PDCP entity is continued and pertinent RLC entity is released and added. In this scenario, one-to-one mapping for PDCP packet and RLC packet may not be guaranteed across cells and hence, RLC entity is released and added. In an embodiment of the disclosure, the PDCP continuation is implemented by a PDCP re-establishment procedure with PDCP state variable continuation for UM MRB used in RRC_INACTIVE state.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP unsynchronized (i.e., not synced) to the source (previous) cell for an MBS multicast service, the existing MRB is released and a new MRB is established/added. A pertinent PDCP entity and/or pertinent RLC entity is established based on the new configuration received via multicast MCCH message in the new cell. The PDCP state variables (e.g., RX_NEXT, RX_DELIV) and/or RLC status variables (e.g., RX_Next_Reassembly, RX_Next_Highest) are set to the initial values. In another embodiment of the disclosure, the initial value of the PDCP state variable(s) and/or RLC status variable(s) are set as per the sequence number of the first received PDCP data PDU for the multicast service on the new cell. In an embodiment of the disclosure, the initial value of the PDCP and/or RLC status variable(s) are set in the new cell as per the UE implementation.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP synced to the source (previous) cell for an MBS multicast service and the new cell is MCCH-less cell, pertinent PDCP entity is continued and pertinent RLC entity is continued. In an embodiment of the disclosure, the PDCP continuation is implemented by a PDCP re-establishment procedure with PDCP state variable continuation for UM MRB used in RRC_INACTIVE state.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP unsynchronized to the source (previous) cell for an MBS multicast service and the new cell is MCCH-less cell, the UE 102 initiates RRC Resume procedure to avail multicast configuration in the RRC_CONNECTED state and pertinent PDCP entity and/or pertinent RLC entity is established as per the new configuration received in the RRC reconfiguration message in RRC_CONNECTED state.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) is PDCP unsynchronized to the source (previous) cell for an MBS multicast service and the new cell provides multicast MCCH, but the relevant PTM configuration for the multicast service is not present in the multicast MCCH message, the UE 102 initiates RRC Resume procedure to avail multicast configuration in the RRC_CONNECTED state and pertinent PDCP entity and/or pertinent RLC entity is established as per the new configuration received in the RRC reconfiguration message in RRC_CONNECTED state.

In an embodiment of the disclosure, when the new cell (i.e., the selected cell during RRC state transition from RRC_CONNECTED state to RRC_INACTIVE state of the UE 102 configured to receive multicast service and/or the reselected cell during mobility of the UE 102 receiving multicast service in RRC_INACTIVE state) provides the same multicast service as the source (previous cell), however, the corresponding logical channel identity (LCID) is different, the pertinent RLC entity is re-established. If the new cell is PDCP synced with the source cell for multicast service, the pertinent PDCP entity is continued. In an embodiment of the disclosure, the PDCP continuation is implemented by a PDCP re-establishment procedure with PDCP state variable continuation for UM MRB used in RRC_INACTIVE state. If the new cell is PDCP unsynchronized with the source cell for multicast service, the pertinent PDCP entity is re-established without PDCP state variable continuation. In an embodiment of the disclosure, the PDCP entity/MBS Radio bearer (MRB) is released and added.

In an embodiment of the disclosure, when the multicast configuration in the multicast MCCH is updated with a change for the corresponding LCID for a multicast service in the RRC_INACTIVE state, the pertinent RLC entity is re-established. The PDCP entity/MRB is released and added. In an embodiment of the disclosure, the PDCP entity is re-established.

In an embodiment of the disclosure, when the multicast configuration in the multicast MCCH is updated (in the same cell or in the new cell) with a change for the corresponding PDCP Sequence number (SN) size for a multicast service in the RRC_INACTIVE state, the PDCP entity/MRB is released and added. In another embodiment of the disclosure, the PDCP entity is re-established.

In an embodiment of the disclosure, multicast configuration includes MRB-ReleaseAndAdd field that indicates the current MRB configuration is released and a new MRB is added at the same time. The multicast configuration may be carried in at least one of multicast MCCH message, RRCRelease with SuspendConfig message, RRCResume message and RRCReconfiguration message.

In an embodiment of the disclosure, when the multicast configuration in the multicast MCCH is updated (in the same cell or in the new cell) with a change for the corresponding RLC Sequence number (SN) size for a multicast service in the RRC_INACTIVE state, the pertinent RLC entity is released and added. In another embodiment of the disclosure, the RLC is re-established. In addition, PDCP entity/MRB may need be released and added together (or re-established).

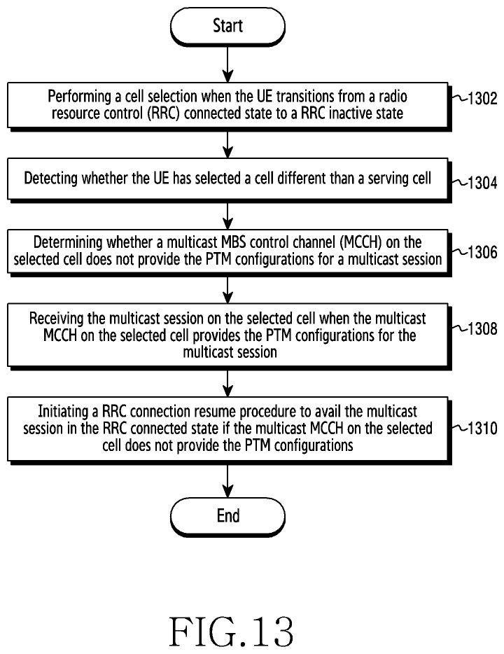

FIG. 13 is a flow diagram that illustrates a method for managing state transitions of a multicast broadcast service (MBS) UE 102 in a wireless network according to an embodiment of the disclosure. The method includes operations 1302-1326. Each operation is explained further below.

Referring to FIG. 13, at operation 1302, a cell selection is performed when the UE 102 transitions from a radio resource control (RRC) connected state to a RRC inactive state. Cell selection is the method by which the UE 102 selects the most appropriate cell to connect with when it is powered on or loses network connectivity. This procedure is critical for ensuring that the UE 102 maintains a stable and dependable connection while providing the best available service depending on signal strength, quality, and network factors. The RRC connected state occurs when the UE 102 maintains an active connection to the network and actively exchanges data or control information. In this condition, the network allocates dedicated resources to the UE 102 and ensures a constant connection with the gNB. Further, the RRC inactive state is an intermediate stage that reduces signaling overhead and saves battery life when the UE 102 is not actively exchanging data but still has to stay connected to the network for speedy reactivation.

At operation 1304, the UE 102 detects whether it has selected a cell different than a serving cell. The serving cell is the cell that manages all data transfers and signals for the UE 102, guaranteeing a steady and dependable connection. For example, the serving cell might consist of a primary serving cell (PCell) and a secondary serving cell (SCell). Further, the UE 102 gets an RRC release message with a suspend configuration that includes point-to-multipoint (PTM) configurations for the serving cell. When the UE 102 is no longer actively transmitting or receiving data, the RRC release message is sent to the network, releasing the current connection. If the UE 102 has been inactive for a long and there is no active data transmission, the network may issue an RRC release message to conserve resources. Another relevant scenario for multicast service delivery is the congestion for the serving cell and as a result, the UE(s) receiving MBS multicast session(s) may be transitioned to RRC inactive state by sending a RRC release message with a suspend configuration including point-to-multipoint (PTM) configurations for multicast session(s).

At operation 1306, the UE 102 determines whether a multicast MBS control channel (MCCH) on the selected cell does not provide the PTM configurations for a multicast session. The multicast MCCH is a control channel for managing multicast services. The multicast MCCH contains critical control information about available MBS services, resource allocations, and session management, allowing the UE 102 or several UEs to join and participate in multicast efficiently. The multicast MCCH is critical in enabling smooth, coordinated communication for applications like live streaming, emergency broadcasts, and group communication services.

At operation 1308, the UE 102 receives the multicast session on the selected cell when the multicast MCCH on the selected cell provides the PTM configurations for the multicast session. Else, at operation 1310, the UE 102 initiates a RRC connection resume procedure to avail the multicast session in the RRC connected state. The RRC connection resume procedure allows the UE 102 to reconnect to the network after being in a low-power mode, such as the RRC inactive state. This approach allows the UE 102 to continue communication without going through the entire connection setup process, decreasing signaling overhead and delay.

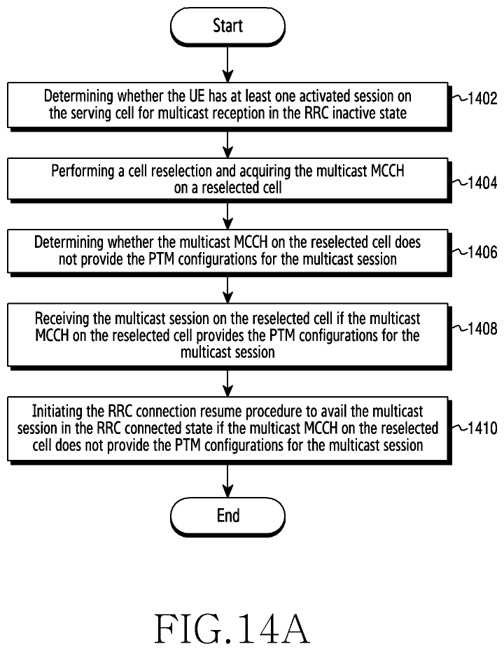

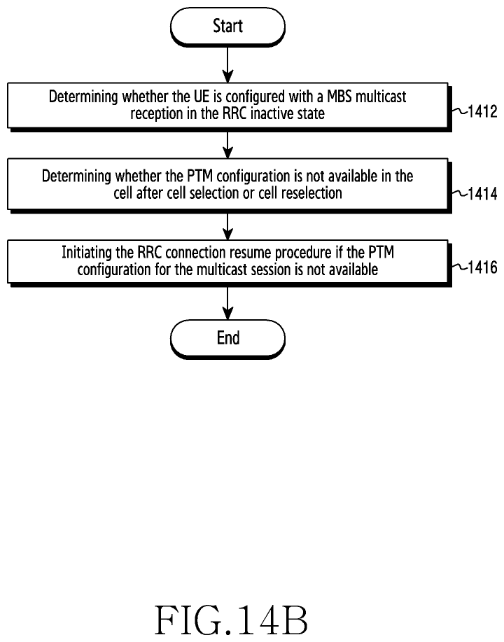

FIG. 14A is a flow diagram that illustrates a method for initiating a RRC connection resume procedure based on PTM configurations according to an embodiment of the disclosure. The method includes operations 1402-1410. Each operation is explained further below.

Referring to FIG. 14A, at operation 1402, the UE 102 determines whether the UE 102 has at least one activated session on the serving cell for multicast reception in the RRC inactive state. The activated session is a continuous session that allows the UE 102 to receive data, voice, or other services via the network. Multicast reception refers to the capacity to provide data to numerous UEs simultaneously using a single transmission rather than delivering independent streams. This capacity is critical for applications requiring large-scale, simultaneous data delivery, such as live video streaming, software upgrades, and public safety warnings. Multicast reception is efficient because it saves network resources by transmitting the same data to several UEs at once.

At operation 1404, the UE 102 performs a cell reselection and acquiring the multicast MCCH on a reselected cell. Cell reselection is a procedure in which the UE 102 selects a new cell to camp on when in RRC inactive state. This happens when the UE 102 is not actively connecting with the network but still needs to stay linked to the optimal cell for future communication requirements. Cell reselection is critical in wireless networks for maintaining optimal connection, network efficiency, and quality of service by ensuring that the UE 102 stays inside the greatest possible coverage area while it moves about.

At operation 1406, the UE 102 determines if the multicast MCCH on the reselected cell does not provide PTM configurations for the multicast session. If the multicast MCCH on the reselection cell has the PTM configurations, then at operation 1408, the UE 102 will receive the multicast session on the reselected cell. Otherwise, at operation 1410, the UE 102 initiates the RRC connection resume procedure to continue the multicast session in the RRC connected state.

FIG. 14B is a flow diagram that illustrates a method for initiating a RRC connection resume procedure based on an availability of PTM configurations for the multicast session according to an embodiment of the disclosure. The method includes operations 1412-1416. Each operation is explained further below.

Referring to FIG. 14B, at operation 1412, the UE 102 determines whether the UE 102 is configured with an MBS multicast reception in the RRC inactive state. MBS multicast reception allows the UE 102 to efficiently accept large-scale data broadcasts from the network. This is especially beneficial for applications that need simultaneous transmission of the same data to several users, such as live streaming, IoT updates, and public safety warnings. Large scale data may be transferred in a single transmission, conserving bandwidth and lowering network load.

At operation 1414, the UE 102 determines whether the PTM configuration is not available in the cell following cell selection or cell reselection for the multicast session that the UE has joined and for which the UE is not instructed to stop monitoring a G-radio network temporary identifier (G-RNTI). The G-RNTI enables the network to deliver a single message that may be received by many UEs that subscribe to the multicast service. G-RNTI enables efficient data transfer to all UEs that subscribe to the multicast service. The G-RNTI identifies the specific multicast session for the UEs in a multicast group who have subscribed to specific services.

At operation 1416, the UE 102 initiates the RRC connection resume procedure if the PTM configuration for the multicast session is not available.

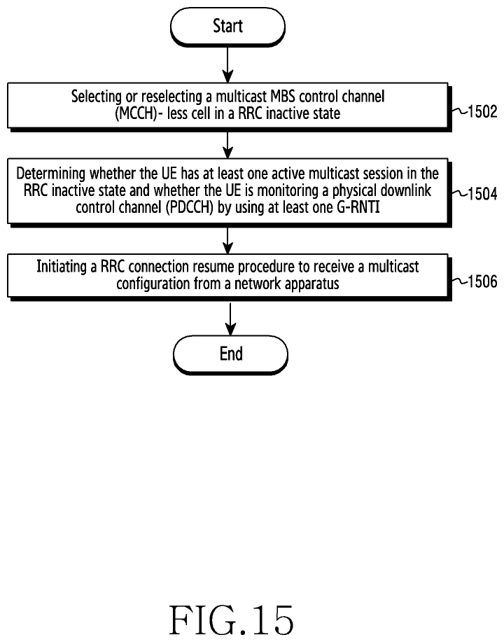

FIG. 15 is a flow diagram that illustrates a method for managing a service continuity of a multicast UE in a wireless network according to an embodiment of the disclosure. The method includes operations 1502-1506. Each operation is explained further below.

Referring to FIG. 15, at operation 1502, the UE 102 selects or reselects a multicast MBS control channel (MCCH)-less cell in a RRC inactive state. The term MCCH-less cell refers to a cell that lacks a dedicated MCCH for MBS control information. Instead, control information is provided only by RRC signalling, while UE is in RRC connected state. Here, the MCCH-less cell might be one on which SIB24 is not scheduled in SIB1. The SIB24 contains information on how the UE 102 may receive and handle multicast data over the network. For example, the SIB24 information may comprise MBS area information, session information, service availability, frequency information, and the like.

At operation 1504, the UE 102 determines whether the UE 102 has at least one active multicast session in the RRC inactive state and whether the UE 102 is monitoring a physical downlink control channel (PDCCH) by using at least one G-RNTI. The PDCCH instructs the UE 102 on how to receive and decode data transmissions on the downlink (DL) and uplink (UL) traffic channels, which is critical for controlling network resource allocation and guaranteeing reliable connection between the network and the UE 102. The PDCCH is crucial for guaranteeing reliable data transmission by implementing effective HARQ management and error correcting techniques.

At operation 1506, when the UE 102 has an active multicast session in the RRC inactive state or is monitoring the PDCCH using the G-RNTI, the RRC connection resume procedure is initiated to receive a multicast configuration from a network apparatus. When the RRC connection resume procedure is initiated, the UE 102 enters an RRC-connected state.

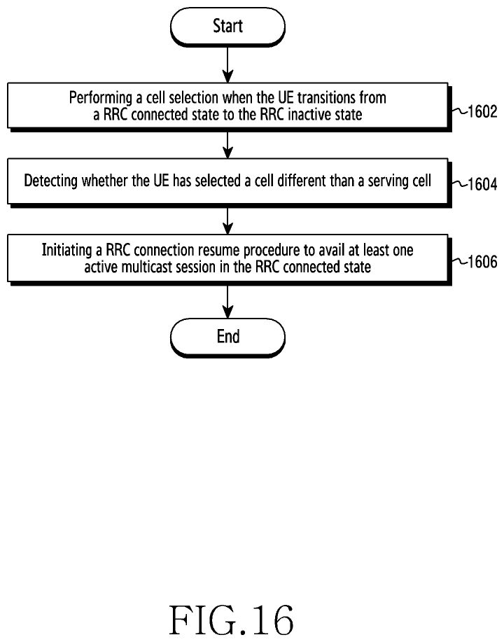

FIG. 16 is a flow diagrams that illustrate a method for initiating a RRC connection resume procedure when a UE transitions from a RRC connected state to a RRC inactive state according to an embodiment of the disclosure. The method includes operations 1602-1606. Each operation is explained further below.

Referring to FIG. 16, at operation 1602, the UE 102 performs a cell selection when the UE 102 transitions from a RRC connected state to the RRC inactive state. When the network determines that the UE 102 does not require a fully active connection but may still restart rapidly, it transitions from the RRC connected to the RRC inactive state. The choice to shift may be influenced by one or more variables, including traffic patterns, network congestion, energy savings, network resource optimizations, and the like.

At operation 1604, the UE 102 determines whether it has selected a cell different than a serving cell in which it received a RRC release message with a suspend configuration including PTM configurations for multicast session, and also determined the selected cell is a MCCH-less cell. If so, then at operation 1606, the UE 102 initiates the RRC connection resume procedure to avail the multicast session in the RRC connected state.

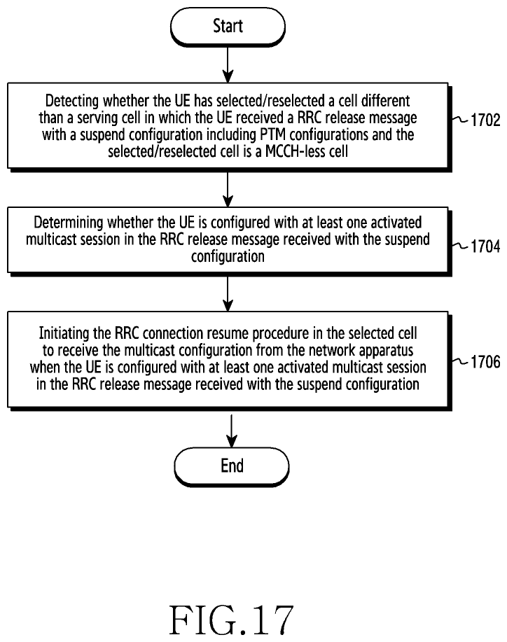

FIG. 17 is a flow diagram that illustrates a method for initiating a RRC connection resume procedure when a UE is configured with an activated multicast session according to an embodiment of the disclosure. The method includes operations 1702-1706. Each operation is explained further below.

Referring to FIG. 17, at operation 1702, the UE 102 determines whether it has selected/reselected a cell different than a serving cell in which it received a RRC release message with a suspend configuration including PTM configurations for multicast session, and also determined the selected cell is a MCCH-less cell.

At operation 1704, the UE 102 determines whether it is configured with the activated multicast session in the RRC release message received with the suspend configuration. The suspend configuration instructs the UE 102 to transit to the RRC inactive state. The suspend configuration consists of the characteristics and information required for the UE 102 to appropriately preserve its state in RRC inactive and guarantee speedy reactivation when necessary.

At operation 1706, the UE 102 initiates the RRC connection resume procedure in the selected cell to receive the multicast configuration from the network apparatus. The RRC connection resume procedure is triggered when the UE 102 receives an RRC release message with an active multicast session. When the RRC connection resume procedure is initiated, the UE 102 enters the RRC connected state.

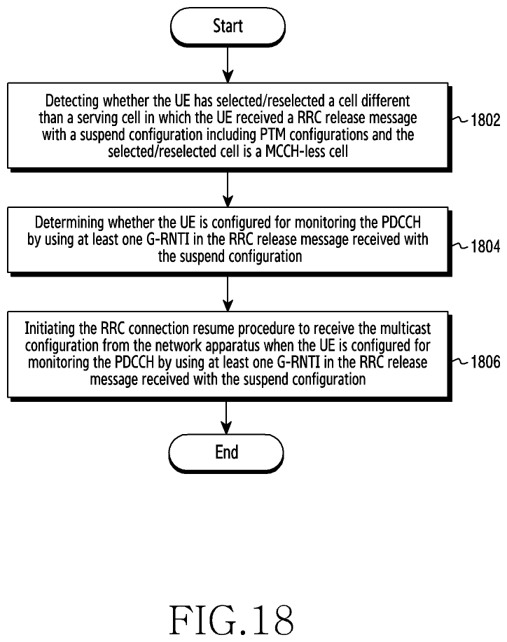

FIG. 18 is a flow diagram that illustrates a method for initiating a RRC connection resume procedure based on a PDCCH monitoring using a G-RNTI according to an embodiment of the disclosure. The method includes operations 1802-1804. Each operation is explained further below.

Referring to FIG. 18, at operation 1802, the UE 102 determines whether it has selected/reselected a cell different than a serving cell in which it received a RRC release message with a suspend configuration including PTM configurations for multicast session, and also determined the selected cell is a MCCH-less cell.

At operation 1804, the UE 102 determines whether it is configured for monitoring the PDCCH by using the G-RNTI in the RRC release message received with the suspend configuration. The G-RNTI may be included in the RRC release message to provide a global identifier for the UE 102.

At operation 1806, the UE 102 initiates the RRC connection resume procedure to receive the multicast configuration from the network apparatus. The RRC connection resume procedure is initiated when the UE 102 is configured for monitoring the PDCCH by using the G-RNTI in the RRC release message received with the suspend configuration. The UE transitions to the RRC connected state upon initiation of the RRC connection resume procedure.

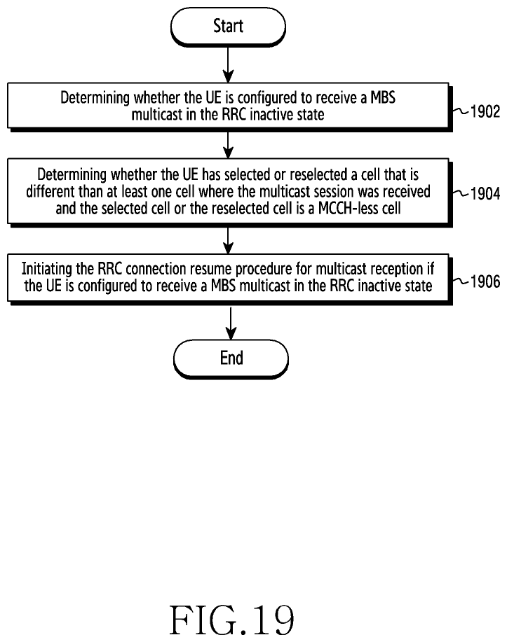

FIG. 19 is a flow diagram that illustrates a method for initiating a RRC connection resume procedure when a UE receives an MBS multicast in a RRC inactive state according to an embodiment of the disclosure. The method includes operations 1902-1906. Each operation is explained further below.

Referring to FIG. 19, at operation 1902, the UE 102 detects whether it is configured to receive an MBS multicast in the RRC inactive state. The MBS multicast enables the UE 102 to easily receive large-scale data broadcasts. This might be useful in applications that need to provide the same data to several users at the same time.

At operation 1904, the UE 102 determines whether it has selected or reselected a cell that is different than the cell where the multicast session was received when the UE 102 is in the RRC connected state and the selected cell or the reselected cell is a MCCH-less cell. If so, then at operation 1906, the UE 102 initiates the RRC connection resume procedure for multicast reception.

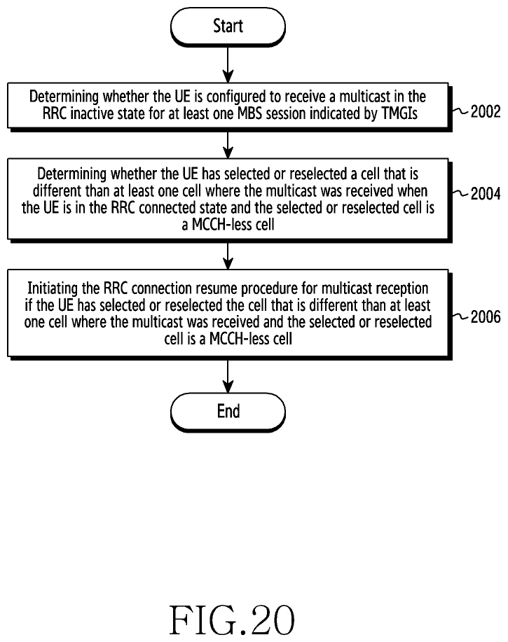

FIG. 20 is a flow diagram that illustrates a method for initiating a RRC connection resume procedure when a UE receives a multicast in a RRC inactive state according to an embodiment of the disclosure. The method includes operations 2002-2006. Each operation is explained further below.

Referring to FIG. 20, at operation 2002, the UE 102 determines whether it is configured to receive a multicast in the RRC inactive state for an MBS session indicated by temporary mobile group identities (TMGIs). For instance, the TMGIs indications are provided in a group paging message. TMGIs are used to identify and group UEs that have subscribed to a certain multicast service. This grouping allows for the efficient dissemination of the same data to numerous UEs at once. When a multicast session is running, the network employs TMGIs to page or alert the appropriate UEs of the data being relayed. This guarantees that only users who have subscribed to the appropriate multicast service can access the relevant contents.

At operation 2004, the UE 102 determines whether it has selected or reselected a cell that is different than the cell where the multicast was received when the UE 102 is in the RRC connected state and the selected or reselected cell is a MCCH-less cell. If so, then at operation 2006, the UE 102 initiates the RRC connection resume procedure for multicast reception.

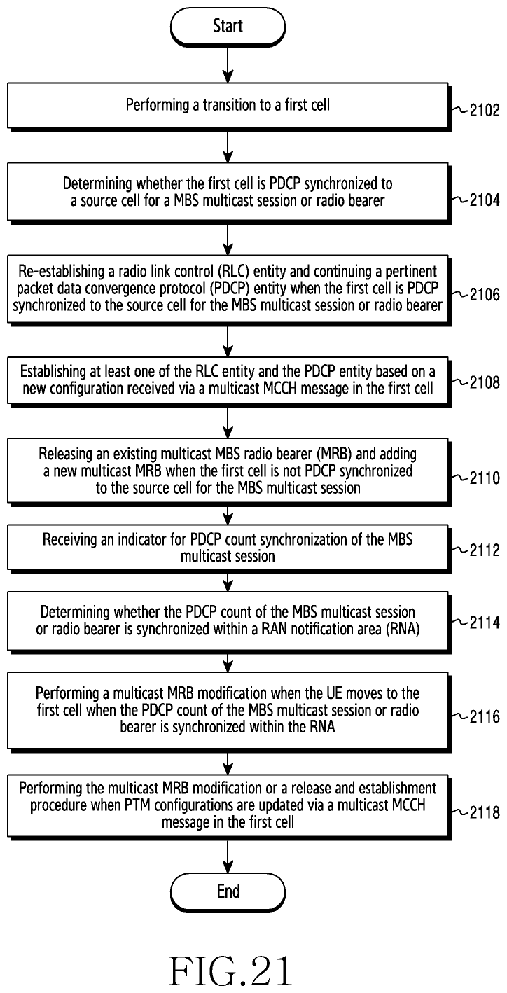

FIG. 21 is a flow diagram that illustrates a method for managing PDCP synchronizations of a multicast UE in a wireless network according to an embodiment of the disclosure. The method includes operation 2102-2118. Each operation is explained further below.

Referring to FIG. 21, at operation 2102, the UE 102 performs a transition to a first cell. For instance, the first cell may include a selected cell determined during a transition of the UE 102 from a RRC connected state to a RRC inactive state configured to receive a multicast session, and a reselected cell determined during a mobility of the UE 102 receiving the multicast session in the RRC inactive state. The mobility refers to the capacity of the UE 102 to move from one area to another while maintaining a continuous and efficient wireless network connection.

At operation 2104, the UE 102 determines whether the first cell is PDCP synchronized to a source cell for an MBS multicast session or radio bearer. PDCP synchronization is critical for ensuring that data delivered to or from the UE 102 is consistent and reliable during mobility events, such as handovers, or while changing states. PDCP synchronization is critical for assuring smooth data delivery, enhancing user experience, and increasing network efficiency. To guarantee that data sessions remain uninterrupted, the PDCP synchronization process includes context transfer, buffering, and re-establishment protocols. Furthermore, the radio carrier is intended to manage data transmission for a variety of traffic kinds, including phone conversations, video streams, and internet data. It offers the resources and protocols required for user data transmission and communication.

At operation 2106, the UE 102 re-establishes a radio link control (RLC) entity and continues a pertinent packet data convergence protocol (PDCP) entity when the first cell is PDCP synchronized to the source cell for the MBS multicast session or radio bearer. The RLC entity is responsible for managing data link layer functions between the UE 102 and the network. For instance, the data link layer functions may include segmentation, retransmission, protocol data unit (PDU) transfer, and the like. The PDCP entity handles data processing and protocol management functions related to user data and signaling.

At operation 2108, the UE 102 establishes the RLC entity and the PDCP entity based on a new configuration received via a multicast MCCH message in the first cell. Such a setup happens when the initial cell is not PDCP synchronized with the source cell for the MBS multicast session or radio bearer. The multicast MCCH message contains control information for multicast services. It manages and configures multicast sessions, telling the UE 102 about available multicast services, scheduling, and session settings.

At operation 2110, the UE 102 releases the existing multicast MBS radio bearer (MRB) and adds a new multicast MRB when the first cell is not PDCP synchronized to the source cell for the MBS multicast session. The MRB is a logical channel that sends multicast data to the UE 102 or many UEs in the wireless network. The MRB is an integral feature of the MBS framework and is vital to the efficient and successful transmission of multicast content. To offer consumers with a smooth multicast experience, the MRB manages resources, transmits data, and coordinates with other channels.

At operation 2112, the UE 102 receives an indicator for PDCP count synchronization of the MBS multicast session. PDCP count synchronization is a mechanism that guarantees that the PDCP's sequence numbers and counters are properly synced amongst network entities during handovers or transitions. This synchronization ensures data integrity, continuity, and security as the UE 102 travels between cells.

At operation 2114, the UE 102 determines whether the PDCP count of the MBS multicast session or radio bearer is synchronized within a RAN notification area (RNA). The RNA is a geographical region designated for the management and optimization of signals of the UE 102. The RNA is beneficial in settings that need mobility and paging.

At operation 2116, the UE 102 performs a multicast MRB modification when the UE moves to the first cell when the PDCP count of the MBS multicast session or radio bearer is synchronized within the RNA. Multicast MRB modification is the process of altering the MRB configuration to react to changes in multicast service needs, network circumstances, or the requests of the UE 102. For example, multicast MRB modifications may involve QoS changes, resource allocations, service changes, and the like.

At operation 2118, the UE 102 performs the multicast MRB modification or a release and establishment procedure when PTM configurations are updated via a multicast MCCH message in the first cell, and when the PDCP count of the MBS multicast session or radio bearer is not synchronized within the RNA. The release process terminates an active bearer that is no longer required. It entails issuing requests and directives to deactivate the bearer and free related resources, hence improving network performance and resource utilization. The establishing operations create a new radio bearer to handle user data and signaling. Requests and orders are sent between the UE 102, network components, and the core network in order to setup and activate the bearer with the desired QoS values.

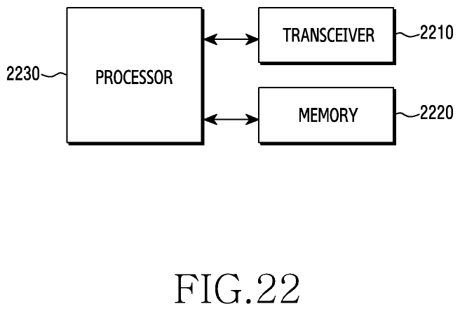

FIG. 22 is a block diagram of a terminal (or a user equipment (UE)), according to an embodiment of the disclosure. FIG. 22 corresponds to the example of the UE of FIGS. 1A, 1B, and 1C.

Referring to FIG. 22, the UE according to an embodiment may include a transceiver 2210, memory 2220, and a processor 2230. The transceiver 2210, the memory 2220, and the processor 2230 of the UE may operate according to a communication method of the UE described above. However, the components of the UE are not limited thereto. For example, the UE may include more or fewer components than those described above. In addition, the processor 2230, the transceiver 2210, and the memory 2220 may be implemented as a single chip. In addition, the processor 2230 may include at least one processor.

The transceiver 2210 collectively refers to a UE receiver and a UE transmitter, and may transmit/receive a signal to/from a base station or a network entity. The signal transmitted or received to or from the base station or a network entity may include control information and data. The transceiver 2210 may include a RF transmitter for up-converting and amplifying a frequency of a transmitted signal, and a RF receiver for amplifying low-noise and down-converting a frequency of a received signal. However, this is only an example of the transceiver 2210 and components of the transceiver 2210 are not limited to the RF transmitter and the RF receiver.

In addition, the transceiver 2210 may receive and output, to the processor 2230, a signal through a wireless channel, and transmit a signal output from the processor 2230 through the wireless channel.

The memory 2220 may store a program and data required for operations of the UE. In addition, the memory 2220 may store control information or data included in a signal obtained by the UE. The memory 2220 may be a storage medium, such as read-only memory (ROM), random access memory (RAM), hard disk, CD-ROM, and a DVD, or a combination of storage media.

The processor 2230 may control a series of processes such that the UE operates as described above. For example, the transceiver 2210 may receive a data signal including a control signal transmitted by the base station or the network entity, and the processor 2230 may determine a result of receiving the control signal and the data signal transmitted by the base station or the network entity.

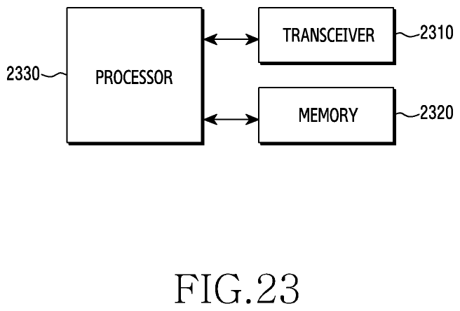

FIG. 23 illustrates a block diagram of a base station, according to an embodiment of the disclosure.

Referring to FIG. 23, the base station according to an embodiment may include a transceiver 2310, memory 2320, and a processor 2330. The transceiver 2310, the memory 2320, and the processor 2330 of the base station may operate according to a communication method of the base station described above. However, the components of the base station are not limited thereto. For example, the base station may include more or fewer components than those described above. In addition, the processor 2330, the transceiver 2310, and the memory 2320 may be implemented as a single chip. In addition, the processor 2330 may include at least one processor.

The transceiver 2310 collectively refers to a base station receiver and a base station transmitter, and may transmit/receive a signal to/from a terminal or a network entity. The signal transmitted or received to or from the terminal or a network entity may include control information and data. The transceiver 2310 may include a RF transmitter for up-converting and amplifying a frequency of a transmitted signal, and a RF receiver for amplifying low-noise and down-converting a frequency of a received signal. However, this is only an example of the transceiver 2310 and components of the transceiver 2310 are not limited to the RF transmitter and the RF receiver.

In addition, the transceiver 2310 may receive and output, to the processor 2330, a signal through a wireless channel, and transmit a signal output from the processor 2330 through the wireless channel.

The memory 2320 may store a program and data required for operations of the base station. In addition, the memory 2320 may store control information or data included in a signal obtained by the base station. The memory 2320 may be a storage medium, such as read-only memory (ROM), random access memory (RAM), a hard disk, a CD-ROM, and a DVD, or a combination of storage media.

The processor 2330 may control a series of processes such that the base station operates as described above. For example, the transceiver 2310 may receive a data signal including a control signal transmitted by the terminal, and the processor 2330 may determine a result of receiving the control signal and the data signal transmitted by the terminal.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station (BS), a radio resource control (RRC) release message including multicast broadcast service (MBS) configuration information, wherein the MBS multicast configuration is associated with reception of an MBS multicast in an RRC inactive state;
performing a cell selection of a cell; and
in case that the UE is not indicated to stop monitoring a group radio network temporary identifier (G-RNTI) for a multicast session that the UE has joined for the cell, performing an RRC connection resume procedure.

2. The method of claim 1,
wherein, in case that a point-to-multipoint (PTM) configuration for the multicast session is not available in the cell, the RRC connection resume procedure is performed, and
wherein the PTM configuration is included in the MBS configuration information.

3. The method of claim 1, further comprising:
receiving a system information block 1 (SIB1) on the cell,
wherein, in case that the SIB1 does not scheduled an SIB24, the RRC connection resume procedure is performed, and
wherein the SIB24 is associated with an MBS reception in the RRC inactive state in the cell.

4. The method of claim 1, further comprising:
receiving, from the BS, a paging message including configuration information for the reception of the MBS multicast in the RRC inactive state for the multicast session; and
monitoring the G-RNTI corresponding to a temporary mobile group identity (TMGI) included in the paging message,
wherein, in case that an MBS control channel (MCCH) for the multicast session indicated by the TMGI is not present in the cell, the RRC connection resume procedure is performed.

5. The method of claim 1,
wherein the cell is different from a cell on which the RRC release message is received.

6. A method performed by a base station (BS) in a wireless communication system, the method comprising:
transmitting, to a user equipment (UE), a radio resource control (RRC) release message including multicast broadcast service (MBS) configuration information, wherein the MBS multicast configuration is associated with reception of an MBS multicast in an RRC inactive state; and
receiving, from the UE, a message for an RRC connection resume procedure,
wherein the RRC connection resume procedure is performed in case that stop monitoring group radio network temporary identifier (G-RNTI) for a multicast session that the UE has joined is not indicated in a cell.

7. The method of claim 6,
wherein, in case that a point-to-multipoint (PTM) configuration for the multicast session is not available in the cell, the RRC connection resume procedure is performed, and
wherein the PTM configuration is included in the MBS configuration information.

8. The method of claim 6, further comprising:
transmitting, to the UE, a paging message including configuration information for the reception of the MBS multicast in the RRC inactive state for the multicast session,
wherein the paging message includes a temporary mobile group identity (TMGI),
wherein the G-RNTI corresponds to the TMGI, and
wherein, in case that an MBS control channel (MCCH) for the multicast session indicated by the TMGI is not present in the cell, the RRC connection resume procedure is performed.

9. The method of claim 6,
wherein the cell is different from a cell on which the RRC release message is transmitted.

10. A user equipment (UE) in a wireless communication system, the UE comprising:
a transceiver; and
a controller coupled with the transceiver and configured to:
receive, from a base station (BS), a radio resource control (RRC) release message including multicast broadcast service (MBS) configuration information, wherein the MBS multicast configuration is associated with reception of an MBS multicast in an RRC inactive state,
perform a cell selection of a cell, and
in case that the UE is not indicated to stop monitoring a group radio network temporary identifier (G-RNTI) for a multicast session that the UE has joined for the cell, perform an RRC connection resume procedure.

11. The UE of claim 10,
wherein, in case that a point-to-multipoint (PTM) configuration for the multicast session is not available in the cell, the RRC connection resume procedure is performed, and
wherein the PTM configuration is included in the MBS configuration information.

12. The UE of claim 10, wherein the controller is further configured to:
receive a system information block 1 (SIB1) on the cell,
wherein, in case that the SIB1 does not scheduled an SIB24, the RRC connection resume procedure is performed, and
wherein the SIB24 is associated with an MBS reception in the RRC inactive state in the cell.

13. The UE of claim 10, wherein the controller is further configured to:
receive, from the BS, a paging message including configuration information for the reception of the MBS multicast in the RRC inactive state for the multicast session, and
monitor the G-RNTI corresponding to a temporary mobile group identity (TMGI) included in the paging message,
wherein, in case that an MBS control channel (MCCH) for the multicast session indicated by the TMGI is not present in the cell, the RRC connection resume procedure is performed.

14. The UE of claim 10,
wherein the cell is different from a cell on which the RRC release message is received.

15. A base station (BS) in a wireless communication system, the base station comprising:
a transceiver; and
a controller coupled with the transceiver and configured to:
transmit, to a user equipment (UE), a radio resource control (RRC) release message including multicast broadcast service (MBS) configuration information,
wherein the MBS multicast configuration is associated with reception of an MBS multicast in an RRC inactive state, and
receive, from the UE, a message for an RRC connection resume procedure,
wherein the RRC connection resume procedure is performed in case that stop monitoring group radio network temporary identifier (G-RNTI) for a multicast session that the UE has joined is not indicated in a cell.

16. The BS of claim 15,
wherein, in case that a point-to-multipoint (PTM) configuration for the multicast session is not available in the cell, the RRC connection resume procedure is performed, and
wherein the PTM configuration is included in the MBS configuration information.

17. The BS of claim 15, wherein the controller is further configured to:
transmit, to the UE, a paging message including configuration information for the reception of the MBS multicast in the RRC inactive state for the multicast session,
wherein the paging message includes a temporary mobile group identity (TMGI),
wherein the G-RNTI corresponds to the TMGI, and
wherein, in case that an MBS control channel (MCCH) for the multicast session indicated by the TMGI is not present in the cell, the RRC connection resume procedure is performed.

18. The BS of claim 15,
wherein the cell is different from a cell on which the RRC release message is transmitted.
